(19) United States
(12) Patent Application Publication
(10) Pub. No.: US 2021/0370218 A1
(43) Pub. Date: Dec. 2, 2021

(54) FILTER MEDIA COMPRISING ADSORPTIVE PARTICLES

(71) Applicant: Hollingsworth & Vose Company, East Walpole, MA (US)

(72) Inventors: Juliane Daus, Frankenberg (DE); Abdoulave Doucouré, Roanoke, VA (US); Greg Wagner Farell, Radford, VA (US); Syed Gulrez, Lancaster (GB); Brian Swortzel, Floyd, VA (US); David T. Healey, Bellingham, MA (US)

(21) Appl. No.: 16/888,523

(22) Filed: May 29, 2020

(51) Int. Cl. B01D 53/04; B01D 46/00

(52) U.S. Cl. CPC B01D 53/04; B01D 46/0036; B01D 46/0023; B01D 2257/708; B01D 2239/1233; B01D 2253/304; B01D 2239/0636; B01D 2239/0681; B01D 2253/102

(57) ABSTRACT

Filter media comprising adsorptive particles are generally described. In some embodiments, the adsorptive particles are present in a relatively large amount, in a layer discrete from one or more other layers and/or fiber webs also present in the filter media, and/or in a layer that comprises a relatively low amount of fibers. In some embodiments, the filter media further comprises a non-woven fiber web comprising fibers with relatively small diameters.

### FIELD

The present invention relates generally to filter media, and, more particularly, to filter media comprising adsorptive particles.

### BACKGROUND

Filter media may be employed in a variety of applications to remove contaminants from fluids. However, some filter media may do a poor job of removing gaseous contaminants from such fluids.

Accordingly, improved filter media designs are needed.

### SUMMARY

Filter media, related components, and related methods are generally described.

In some embodiments, a filter media is provided. The filter media comprises a first non-woven fiber web and a layer comprising adsorptive particles. The first non-woven fiber web comprises fibers having an average fiber diameter of less than or equal to 1 micron. The layer comprising adsorptive particles is discrete from the first non-woven fiber web.

In some embodiments, the filter media comprises a first non-woven fiber web and a layer comprising adsorptive particles. The first non-woven fiber web comprises fibers having an average fiber diameter of less than or equal to 1 micron. Fibers make up less than or equal to 20 wt % of the layer comprising adsorptive particles.

In some embodiments, the filter media comprises a first non-woven fiber web and a layer comprising adsorptive particles. The first non-woven fiber web comprises fibers having an average fiber diameter of less than or equal to 1 micron. The layer comprising adsorptive particles comprises adsorptive particles in an amount such that the adsorptive particles have a basis weight of greater than or equal to 90 g/m² and less than or equal to 1000 g/m².

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 shows one non-limiting example of a filter media having two layers, in accordance with some embodiments;

FIG. 2 shows one non-limiting example of a filter media having three layers, in accordance with some embodiments;

FIG. 3 shows one non-limiting example of a filter media having four layers, in accordance with some embodiments;

FIG. 4 shows one non-limiting example of a filter media having five layers, in accordance with some embodiments; and

FIG. 5 shows one non-limiting example of a filter media comprising a layer comprising adsorptive particles and lacking fibers.

### DETAILED DESCRIPTION

Filter media comprising adsorptive particles are generally described. In some embodiments, the adsorptive particles are present in a relatively large amount, in a layer discrete from one or more other layers and/or fiber webs also present in the filter media, and/or in a layer that comprises a relatively low amount of fibers. In some embodiments, the filter media further comprises a non-woven fiber web comprising fibers with relatively small diameters (e.g., the non-woven web may be a layer comprising nanofibers, also referred to as a nanofiber layer).

In some embodiments, the presence of adsorptive particles in a filter media may advantageously enhance the ability of the filter media to remove contaminants from fluids. In particular, adsorptive particles may be particularly beneficial for removing contaminants from fluids that may be challenging to remove by filtration. Such contaminants may have particularly small sizes and/or may be in a form (e.g., a gaseous form) that allows them to flow through small orifices and/or tortuous pathways. Adsorptive particles may be capable of removing such contaminants from fluids by one or more chemical interactions (e.g., by adsorption) without relying on physical sieving techniques.

Filter media comprising both adsorptive particles and fibrous layers may beneficially be capable of removing a variety of contaminants from fluids. The adsorptive particles may be capable of removing some contaminants by adsorption, and the fibrous layers may be capable of removing further contaminants by physically blocking their passage through the filter media. Together, both components may remove a variety of contaminants from the fluid to a high degree. When the fibrous layer comprises fibers with a relatively low diameter (e.g., when it is a nanofiber layer), the filter media may be capable of removing even relatively small particulate contaminants to a high degree, further enhancing performance.

In some embodiments, the incorporation of adsorptive particles into a filter media in a discrete layer and/or a layer comprising a relatively low amount of fibers, may be particularly beneficial. Without wishing to be bound by any particular theory, it is believed that such designs may allow for filter media to comprise a relatively high amount of adsorptive particles. The presence of other components in the layer, such as fibers, may reduce the density of the adsorptive particles in the layer while adding weight, thickness, and, in some cases, cost to the filter media. Therefore, filter media comprising a discrete layer of adsorptive particles and/or a layer comprising adsorptive particles in a relatively high amount may be able to provide higher and, in some cases more economical, performance than filter media comprising adsorptive particles positioned in a layer comprising an appreciable amount of fibers.

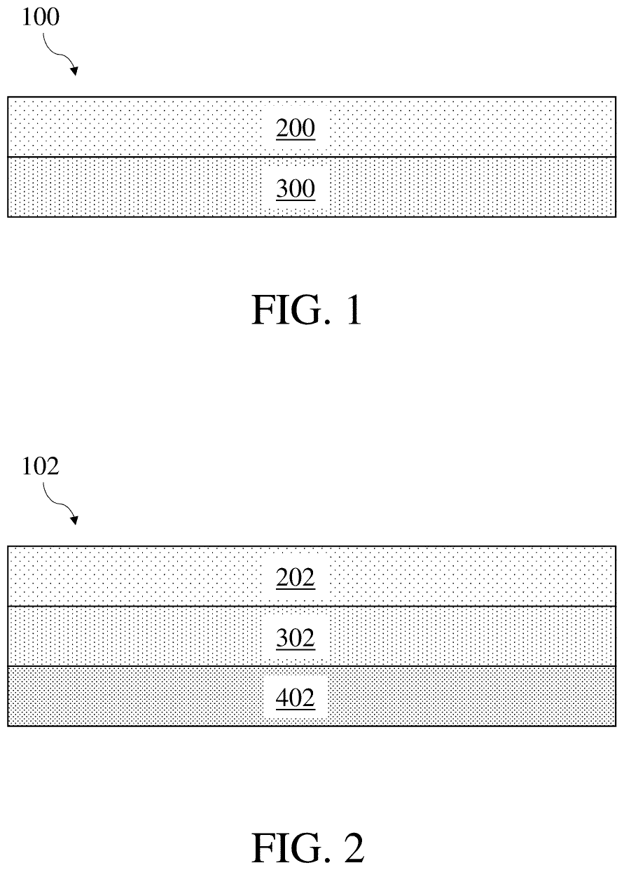

The filter media described herein typically comprise at least two layers: a layer comprising adsorptive particles and a fibrous layer. FIG. 1 shows one non-limiting embodiment of a filter media having this structure. In FIG. 1, the filter media 100 comprises a first layer 200 and a second layer 300. The first layer may comprise adsorptive particles. The second layer may comprise fibers. For instance, the second layer may be a non-woven fiber web, such as a nanofiber layer.

As shown in FIG. 1, a layer comprising adsorptive particles may be discrete from one or more layers to which it is adjacent and/or directly adjacent. In other words, the layer comprising adsorptive particles may be a separate from these layer(s). For instance, the layer comprising adsorptive particles may interpenetrate to only a minimal degree, if at all, with layers from which it is discrete (e.g., less than 5%, less than 2%, or less than 1% of the thickness of the layer comprising adsorptive particles may penetrate into a layer from which it is discrete and/or less than 5%, less than 2%, or less than 1% of the thickness of the layer from which it is discrete may penetrate into the layer comprising adsorptive particles). Such interpenetration, or lack thereof, may be determined by scanning electron microscopy. As another example, in some embodiments, an interface between the layer comprising adsorptive particles and a layer from which it is discrete can be readily determined (e.g., by microscopy). At the interface, there may be a step change in one or more properties (e.g., composition, solidity, air permeability). As a third example, in some embodiments, a component is positioned between the layer comprising adsorptive particles and a layer from which it is discrete (e.g., an adhesive).

As used herein, when a layer is referred to as being “on” or “adjacent” another layer, it can be directly on or adjacent the layer, or an intervening layer also may be present. A layer that is “directly on”, “directly adjacent” or “in contact with” another layer means that no intervening layer is present.

In some embodiments, a filter media further comprises additional layers beyond those shown in FIG. 1. For instance, as shown in FIG. 2, a filter media may comprise three layers. In FIG. 2, the filter media 102 comprises a first layer 202, a second layer 302, and a third layer 402. The first layer 202 may be a layer comprising adsorptive particles. The second layer 302 may be a fibrous layer, such as a nanofiber layer. The third layer 402 may be another fibrous layer. For instance, when the filter media comprises a second layer that is a nanofiber layer, the third layer may be a support layer, such as a scrim. When present, the support layer may comprise coarse fibers, be relatively open (e.g., have an air permeability in excess of 300 CFM), and/or support the nanofiber layer. When the filter media comprises a layer of this type, it may be positioned in the location shown in FIG. 2 (e.g., adjacent a nanofiber layer on a side opposite a layer comprising adsorptive particles) or in a different location. For instance, in some embodiments, a filter media comprises a support layer that is positioned between a nanofiber layer and a layer comprising adsorptive particles.

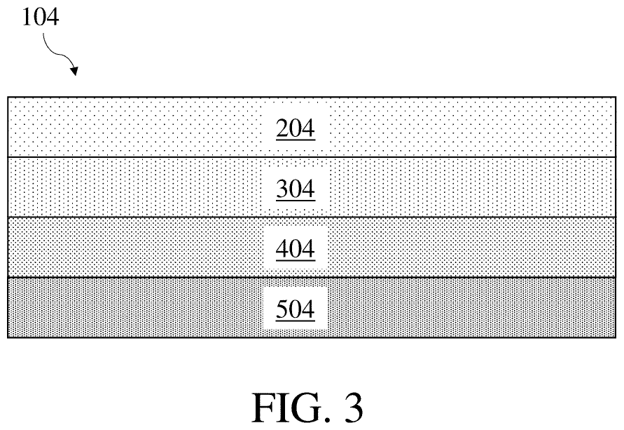

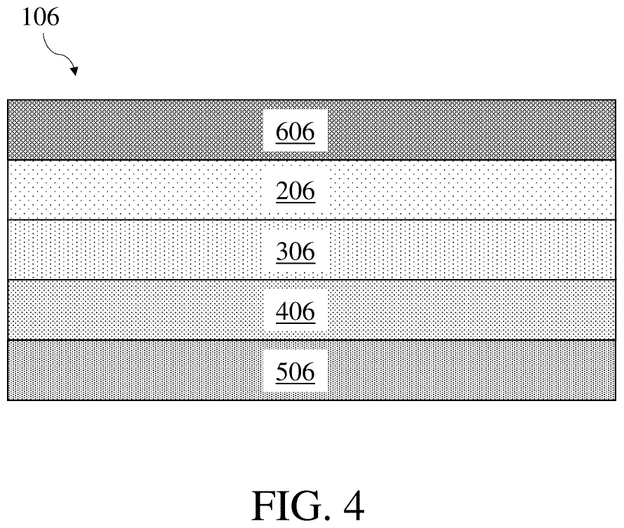

FIG. 3 shows a further example of a filter media comprising more than two layers. In FIG. 3, the filter media 104 comprises a first layer 204, a second layer 304, a third layer 404, and a fourth layer 504. The first layer 204 may be a layer comprising adsorptive particles. The second through fourth layers 304-504 may be fibrous layers. As an example, in some embodiments, a filter media comprises a second layer that is a nanofiber layer and a fourth layer that comprises coarser fibers than the nanofiber layer. This layer comprising coarser fibers may serve as a prefilter to the nanofiber layer and/or serve as a capacity layer. It should also be noted that, in some embodiments, a filter media may comprise a nanofiber layer and a prefilter but not a support layer and/or may comprise a single layer that serves as both a prefilter and a support layer. In other words, in some embodiments, the third layer shown in FIG. 2 may be a prefilter.

While FIG. 3 shows one exemplary design of a filter media, it should be understood that some filter media may differ from that shown in FIG. 3 in one or more ways. For instance, in some embodiments, a filter media may comprise the layers shown in FIG. 3 arranged in an order other than that shown in FIG. 3. For instance, in some embodiments, a filter media comprises a nanofiber layer positioned between a scrim and a prefilter (e.g., directly between a scrim and a prefilter). The layer comprising adsorptive particles may be positioned adjacent (e.g., directly) the scrim or the prefilter.

FIG. 4 depicts a fourth exemplary filter media comprising five layers. In FIG. 4, the filter media 106 comprises a first layer 206, a second layer 306, a third layer 406, a fourth layer 506, and a fifth layer 606. The first layer 206 may be a layer comprising adsorptive particles. The second through fifth layers 306-506 may be fibrous layers. In some embodiments, a filter media comprises a fifth layer that supports the layer comprising adsorptive particles (e.g., a second support layer, the only support layer for filter media in which the nanofiber layer is not supported by a support layer). Filter media may include this layer but lack other layers. For instance, in some embodiments, a filter media comprises a support layer for the layer comprising adsorptive particles but lacks a support layer for a nanofiber layer and/or a lacks a prefilter. It is also possible for a filter media to comprise a support layer for the layer comprising adsorptive particles that is positioned in a different location from that shown in FIG. 4. For instance, in some embodiments, a filter media comprises a support layer for a layer comprising adsorptive particles that is positioned between that layer and other layers of the filter media (e.g., between the layer comprising adsorptive particles and a nanofiber layer, between the layer comprising adsorptive particles and a support layer for the nanofiber layer, between the layer comprising adsorptive particles and a prefilter).

Three further exemplary combinations of layers in a filter media are as follows: support layer/nanofiber layer/prefilter/layer comprising adsorptive particles/support layer, prefilter/nanofiber layer/support layer/layer comprising adsorptive particles/support layer, support layer/layer comprising adsorptive particles/prefilter/nanofiber layer/support layer, support layer/prefilter/nanofiber layer/layer comprising adsorptive particles/support layer, support layer/nanofiber layer/layer comprising adsorptive particles/layer comprising adsorptive particles/support layer, and support layer/nanofiber layer/prefilter/layer comprising adsorptive particles/layer comprising adsorptive particles/support layer. For these filter media, and others described herein, it should be understood that they may be arranged in a filter element so that either of the outermost layers is positioned on the upstream side and either of the outermost layers is positioned on the downstream side. For instance, the second filter media in the first sentence in this paragraph may be arranged so that the prefilter is on the upstream side or so that the support layer for the layer comprising adsorptive particles is on the upstream side.

It is also possible that for a filter media to comprise further layers than those shown in FIGS. 1-4. For instance, some filter media may comprise six, seven, eight, nine, or even more layers. Some of such layers may be fibrous and/or some may be non-fibrous. Similarly, some layers may be of one or more of the types described herein and/or some layers may be of a type not described herein. In some embodiments, a filter media may comprise two or more layers of a single type (e.g., two or more support layers, two or more nanofiber layers, two or more layers comprising adsorptive particles, two or more prefilter layers). In such cases, it should be understood that each layer of the relevant type may independently have some, all, or none of the properties described herein with respect to that layer type. It should also be understood that two or more layers of a common type may be identical or may differ in one or more ways. For instance, in some embodiments, a filter media comprises two layers comprising adsorptive particles that differ in one or more ways. Examples of such differences may include differences in the average diameter of the adsorptive particles and/or differences in the type of adsorptive particle.

The first, second, third fiber, and fourth layers shown in the filter media of FIGS. 1-4 may be referred to elsewhere herein by names that connote their functionality (e.g., “prefilter”, “support layer”, “nanofiber layer”). These references should be understood to be for convenience and to convey functionality that these fiber webs may have when appropriately designed and arranged. However, fiber webs recited in the claims should not be understood to necessarily have the components or properties of any of these layer types unless explicitly reciting such components or properties. In other words, it should be understood that a reference to a “first” fiber web in the claims may not necessarily be reference to a nanofiber layer as described herein, a reference to a “second” fiber web in the claims may not necessarily be a reference to a support layer described herein, and/or a reference to a “third” fiber web in the claims may not necessarily be a reference to a prefilter described herein. By way of example, a “first” fiber web may have one or more properties in common with the support layers and/or prefilters described herein, may lack one or more properties of the nanofiber layers described herein, may have a functionality in the filter media similar to that of a support layer and/or a prefilter, and/or may lack the functionality of a nanofiber layer.

As described elsewhere herein, in some embodiments, a filter media comprises a layer comprising adsorptive particles. The layer comprising adsorptive particles may be capable of and/or configured to remove a contaminant from a fluid. The adsorption may comprise physical adsorption (e.g., via weak interactions, such as van der Waals forces and/or hydrogen bonds) and/or may comprise chemical adsorption (e.g., via stronger interactions, such as covalent and/or ionic bonds). Further details regarding this layer are provided below.

A variety of types of adsorptive particles may be included in the filter media described herein. One example of a suitable type of adsorptive particle is activated carbon particles. Without wishing to be bound by any particular theory, it is believed that activated carbon particles may be capable of physically adsorbing one or more contaminants. The activated carbon may be derived from coconut shells or from wood. In some embodiments, the activated carbon particles are also surface-treated. Non-limiting examples of surface treatments include treatment such that the activated carbon transforms into chemically-active carbon, treatment with calcium carbonate, treatment with potassium iodide, treatment with tris-hydroxymethyl-aminomethane, treatment with phosphoric acid, treatment with a metal (e.g., a transition metal, such as copper, silver, zinc, and/or molybdenum) and treatment with triethylenediamine.

In some embodiment, surface-treating activated carbon comprises impregnating activated carbon with the species with which it is being surface-treated in order to cause a chemical reaction at the surface of the activated carbon. The species surface-treating the activated carbon is present in an amount of between 0.5% and 30% of the weight of the activated carbon (e.g., between 2% and 10% of the weight of the activated carbon) during this process. After surface treatment, the activated carbon may comprise functional groups comprising nitrogen (e.g., amine groups), polar functional groups, and/or functional groups comprising sulfur (e.g., sulfur bound to the activated carbon matrix). It is also possible for surface treatment to increase the surface area of the activated carbon.

Chemically-active carbon may be formed by treating activated carbon with a metal chloride (e.g., ZnCl₂, FeCl₃, MgCl₂) in the presence of heat. This treatment may cause the activated carbon to exhibit an increase in surface area (e.g., to 500 m²/g to 1000 m²/g) and/or porosity, and/or may cause the pore size distribution in the activated carbon to change. It is also possible for this treatment to cause the formation of phenolic, lactonic, and/or carboxylic-acid functional groups on the activated carbon.

Other suitable types of adsorptive particles include cation-exchange resins, anion-exchange resins, polymers, activated alumina, alloys (e.g., copper-zinc alloys), molecular sieves, metal oxides (e.g., copper oxide, titanium dioxide), zeolites, and salts (e.g., metal chloride salts, metal bicarbonate salts including sodium bicarbonate, sulfate salts).

Non-limiting examples of suitable cation-exchange resins include species comprising negatively-charged and/or acidic functional groups (e.g., sulfuric acid functional groups, sulfonic acid functional groups, and/or acrylic acid functional groups). For instance, some cation-exchange resins may comprise poly(styrene sulfonic acid) and/or poly(acrylic acid).

Non-limiting examples of suitable anion-exchange resins include species comprising positively-charged and/or basic functional groups, such as amine functional groups (e.g., primary amine functional groups, secondary amine functional groups, tertiary amine functional groups, quaternary amine functional groups). For instance, some anion-exchange resins may comprise poly(ethyleneimine), poly(diallyl dimethyl ammonium chloride), and/or poly(4-vinylpyrridinium).

Suitable superabsorbent polymers may be capable of adsorbing one or more liquids (e.g., water) in an amount in excess of their weight. Non-limiting examples of suitable superabsorbent polymers include poly(acrylate), poly(acrylamide), carboxymethylcellulose, copolymers of the foregoing, and cross-linked networks formed from the foregoing.

In some embodiments, activated alumina suitable for inclusion in the filter media described herein is surface treated with a permanganate salt (e.g., sodium permanganate, potassium permanganate, both). The permanganate salt may make up at least 12 wt %, at least 15 wt %, or at least 17.5 wt % of the resultant material. In some embodiments, the permanganate salt makes up that at most 20 wt %, at most 17.5 wt %, or at most 15 wt % of the resultant material. Combinations of the above-referenced ranges are also possible (e.g., at least 12 wt % and at most 20 wt %). Other ranges are also possible.

Non-limiting examples of species (e.g., types of contaminants) that the adsorptive particles may be capable of and/or configured to remove include volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases). Such species may be gaseous or may be liquids. Some of these contaminants may be unpleasantly odorous and some may be toxic. The contaminants may originate from a variety of sources (e.g., microbes, sewage, marshes, farm animals, power generation, fuel processing, plastic manufacturing, steel blast furnaces, the chemical and/or semiconductor industry, automotive combustion, food processing, office buildings, tobacco smoke).

Table 1, below, shows various adsorptive particles and examples species they may be particularly suitable for adsorbing. It should be understood that Table 1 is non-limiting, that the adsorptive particles listed in Table 1 may be configured for and/or capable of adsorbing other types of species than those listed in Table 1, and that the species listed in Table 1 may be configured to be adsorbed by and/or capable of being adsorbed by other types of adsorptive particles than those listed in Table 1.

TABLE 1

| | Species Capable of Being Adsorbed |
|---|---|
| Adsorptive Particle Type | and/or Configured to be Adsorbed |
| Coconut shell-derived activated | Toluene, n-butane, SO₂, NOₓ, |
| carbon, not surface treated | benzene, acetaldehyde, |
| | formaldehyde, H₂S |
| Coconut shell-derived activated | Acidic gases, SO₂, NOₓ, H₂S |
| carbon, surface treated | |
| with calcium carbonate | |
| Coconut shell-derived activated | H₂S |
| carbon, surface treated | |
| with potassium iodide | |
| Coconut shell-derived activated | Aldehydes |
| carbon, surface treated with | |
| tris-hydroxymethyl-aminomethane | |
| Coconut shell-derived activated | Ammonia, amines |
| carbon, surface treated | |
| with phosphoric acid | |
| Coconut shell-derived activated | Gaseous chemical weapons |
| carbon, surface treated with a tran- | |
| sition metal and triethylenediamine | |
| Wood-derived activated carbon | Toluene, n-butane |
| Chemically-active carbon | SO₂, H₂S |
| Cation exchange resin comprising | Ammonia, trimethylamine |
| sulfonic acid functional groups | |
| Superabsorbent polymers | Water |
| Metal oxides | Acidic gases, SO₂, H₂S |
| Activated alumina, not surface | Acidic gases, SO₂, H₂S |
| treated | |
| Activated alumina, surface | Acidic gases, SO₂ |
| treated with 12 wt % | |
| sodium/potassium permanganate | |
| Copper-zinc alloy | Water impurities |
| Zeolites | SO₂, NH₃ |
| Sodium bicarbonate | SO₂ |

It should be understood that some, all, or none of the adsorptive particles listed in Table 1 and described elsewhere herein may be present in the filter media described herein and that the filter media described herein may be suitable for adsorbing some, all, or none of the species listed in Table 1 and described elsewhere herein. In some embodiments, a layer comprising adsorptive particles comprises one type of adsorptive particle, two types of adsorptive particles, three types of adsorptive particles, four types of adsorptive particles, or even more types of adsorptive particles.

When present, adsorptive particles may make up any suitable amount of a layer in which they are positioned. A filter media may comprise a layer comprising one or more types of adsorptive particles in an amount of greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 17.5 wt %, greater than or equal to 20 wt %, greater than or equal to 25 wt %, greater than or equal to 30 wt %, greater than or equal to 35 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the layer. A filter media may comprise a layer comprising one or more types of adsorptive particles in an amount of less than or equal to 95 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 35 wt %, less than or equal to 30 wt %, less than or equal to 25 wt %, less than or equal to 20 wt %, less than or equal to 17.5 wt %, less than or equal to 15 wt %, less than or equal to 12.5 wt %, less than or equal to 10 wt %, less than or equal to 7.5 wt %, less than or equal to 5 wt %, or less than or equal to 2 wt % of the layer. Combinations of the above-referenced ranges are also possible (e.g., greater than or equal to 1 wt % and less than or equal to 95 wt %, or greater than or equal to 30 wt % and less than or equal to 90 wt %). Other ranges are also possible.

In embodiments in which a layer comprises two or more types of adsorptive particles, each type of adsorptive particles may independently be present in the layer in one or more of the ranges described above. In some embodiments, all of the adsorptive particles in a layer together make up an amount of the layer in one or more of the ranges described above. For instance, in some embodiment, all of the adsorptive particles in a layer together make up at least 60 wt % of the layer.

When present, adsorptive particles may have a relatively high basis weight with respect to the filter media as a whole. In some embodiments, the basis weight of the adsorptive particles in a filter media is greater than or equal to 70 g/m², greater than or equal to 80 g/m², greater than or equal to 90 g/m², greater than or equal to 100 g/m², greater than or equal to 125 g/m², greater than or equal to 150 g/m², greater than or equal to 175 g/m², greater than or equal to 200 g/m², greater than or equal to 250 g/m², greater than or equal to 300 g/m², greater than or equal to 400 g/m², greater than or equal to 500 g/m², greater than or equal to 750 g/m², greater than or equal to 1000 g/m², greater than or equal to 1250 g/m², greater than or equal to 1500 g/m², or greater than or equal to 1750 g/m². In some embodiments, the basis weight of the adsorptive particles in a filter media is less than or equal to 2000 g/m², less than or equal to 1750 g/m², less than or equal to 1500 g/m², less than or equal to 1250 g/m², less than or equal to 1000 g/m², less than or equal to 750 g/m², less than or equal to 500 g/m², less than or equal to 400 g/m², less than or equal to 300 g/m², less than or equal to 250 g/m², less than or equal to 200 g/m², less than or equal to 175 g/m², less than or equal to 150 g/m², less than or equal to 125 g/m², less than or equal to 100 g/m², less than or equal to 90 g/m², or less than or equal to 80 g/m². Combinations of the above-referenced ranges are also possible (e.g., greater than or equal to 70 g/m² and less than or equal to 2000 g/m², greater than or equal to 90 g/m² and less than or equal to 1000 g/m², or greater than or equal to 90 g/m² and less than or equal to 250 g/m²). Other ranges are also possible. The basis weight of the adsorptive particles may be determined in accordance with ISO 536:2012.

In embodiments in which a filter media comprises two or more types of adsorptive particles, each type of adsorptive particles may independently be present in the filter media in one or more of the ranges described above. In some embodiments, all of the adsorptive particles in a filter media together make up an amount of the filter media in one or more of the ranges described above.

When present, adsorptive particles may have a variety of suitable average diameters. In some embodiments, a filter media comprises a layer comprising adsorptive particles having an average diameter of greater than or equal to 250 microns, greater than or equal to 300 microns, greater than or equal to 350 microns, greater than or equal to 400 microns, greater than or equal to 450 microns, greater than or equal to 500 microns, greater than or equal to 550 microns, greater than or equal to 600 microns, greater than or equal to 650 microns, greater than or equal to 700 microns, greater than or equal to 750 microns, greater than or equal to 800 microns, greater than or equal to 850 microns, greater than or equal to 900 microns, greater than or equal to 950 microns, greater than or equal to 1 mm, greater than or equal to 1.05 mm, greater than or equal to 1.1 mm, or greater than or equal to 1.15 mm. In some embodiments, a filter media comprises a layer comprising adsorptive particles having an average diameter of less than or equal to 1.2 mm, less than or equal to 1.15 mm, less than or equal to 1.05 mm, less than or equal to 1 mm, less than or equal to 950 microns, less than or equal to 900 microns, less than or equal to 850 microns, less than or equal to 800 microns, less than or equal to 750 microns, less than or equal to 700 microns, less than or equal to 650 microns, less than or equal to 600 microns, less than or equal to 550 microns, less than or equal to 500 microns, less than or equal to 450 microns, less than or equal to 400 microns, less than or equal to 350 microns, or less than or equal to 300 microns. Combinations of the above-referenced ranges are also possible (e.g., greater than or equal to 250 microns and less than or equal to 1.2 mm, or greater than or equal to 250 microns and less than or equal to 850 microns). Other ranges are also possible. The average diameter of adsorptive particles may be determined in accordance with ASTM D2862 (2016).

In embodiments in which a layer comprises two or more types of adsorptive particles, each type of adsorptive particles may independently have an average diameter in one or more of the ranges described above. In some embodiments, all of the adsorptive particles in a layer together have an average diameter in one or more of the ranges described above.

Some filter media may comprise two layers comprising adsorptive particles, each of which comprises adsorptive particles having an average diameter in one or more of the ranges described above and having an average diameter different from that of the adsorptive particles in the other layer. For instance, in some embodiments, a filter media comprises first layer and second layers comprising adsorptive particles, and the adsorptive particles in the first layer have an average diameter that is greater than or equal to 150%, greater than or equal to 200%, greater than or equal to 250%, greater than or equal to 300%, greater than or equal to 350%, greater than or equal to 400%, or greater than or equal to 450% of the average diameter or adsorptive particles in the second layer. In some embodiments, a filter media comprises first layer and second layers comprising adsorptive particles, and the adsorptive particles in the first layer have an average diameter that is less than or equal to 500%, less than or equal to 450%, less than or equal to 400%, less than or equal to 350%, less than or equal to 300%, less than or equal to 250%, or less than or equal to 200% of the average diameter or adsorptive particles in the second layer. Combinations of the above-referenced ranges are also possible (e.g., greater than or equal to 150% and less than or equal to 500%). Other ranges are also possible.

When present, adsorptive particles may have a variety of suitable specific surfaces areas. In some embodiments, a layer comprises adsorptive particles having a specific surface area of greater than or equal to 1 m²/g, greater than or equal to 2 m²/g, greater than or equal to 5 m²/g, greater than or equal to 7.5 m²/g, greater than or equal to 10 m²/g, greater than or equal to 12.5 m²/g, greater than or equal to 15 m²/g, greater than or equal to 17.5 m²/g, greater than or equal to 20 m²/g, greater than or equal to 25 m²/g, greater than or equal to 30 m²/g, greater than or equal to 40 m²/g, greater than or equal to 50 m²/g, greater than or equal to 75 m²/g, greater than or equal to 100 m²/g, greater than or equal to 200 m²/g, greater than or equal to 500 m²/g, greater than or equal to 750 m²/g, greater than or equal to 1000 m²/g, greater than or equal to 1500 m²/g, greater than or equal to 2000 m²/g, greater than or equal to 2500 m²/g, greater than or equal to 3000 m²/g, greater than or equal to 3500 m²/g, greater than or equal to 4000 m²/g, greater than or equal to 4500 m²/g, or greater than or equal to 5000 m²/g. In some embodiments, a layer comprises adsorptive particles having a specific surface area of less than or equal to 5500 m²/g, less than or equal to 5000 m²/g, less than or equal to 4500 m²/g, less than or equal to 4000 m²/g, less than or equal to 3500 m²/g, less than or equal to 3000 m²/g, less than or equal to 2500 m²/g, less than or equal to 2000 m²/g, less than or equal to 1500 m²/g, less than or equal to 1000 m²/g, less than or equal to 750 m²/g, less than or equal to 500 m²/g, less than or equal to 200 m²/g, less than or equal to 100 m²/g, less than or equal to 75 m²/g, less than or equal to 50 m²/g, less than or equal to 40 m²/g, less than or equal to 30 m²/g, less than or equal to 25 m²/g, less than or equal to 20 m²/g, less than or equal to 17.5 m²/g, less than or equal to 15 m²/g, less than or equal to 12.5 m²/g, less than or equal to 10 m²/g, less than or equal to 7.5 m²/g, less than or equal to 5 m²/g, or less than or equal to 2 m²/g. Combinations of the above-referenced ranges are also possible (e.g., greater than or equal to 1 m²/g and less than or equal to 5500 m²/g, greater than or equal to 20 m²/g and less than or equal to 3000 m²/g, or greater than or equal to 20 m²/g and less than or equal to 40 m²/g). Other ranges are also possible. The specific surface area of the adsorptive particles may be measured in accordance with ASTM D5742 (2016).

In embodiments in which a layer comprises two or more types of adsorptive particles, each type of adsorptive particles may independently have a specific surface area in one or more of the ranges described above. In some embodiments, all of the adsorptive particles in a layer together have a specific surface area in one or more of the ranges described above.

In some embodiments, a layer comprising particles further comprises multicomponent fibers. The multicomponent fibers may comprise bicomponent fibers (i.e., fibers including two components), and/or may comprise fibers comprising three or more components. Multicomponent fibers may have a variety of suitable structures. For instance, a layer comprising adsorptive particles may comprise one or more of the following types of bicomponent fibers: core/sheath fibers (e.g., concentric core/sheath fibers, non-concentric core-sheath fibers), segmented pie fibers, side-by-side fibers, tip-trilobal fibers, and “island in the sea” fibers. Core-sheath bicomponent fibers may comprise a sheath that has a lower melting temperature than that of the core. When heated (e.g., during a binding step), the sheath may melt prior to the core, binding the adsorptive particles together while the core remains solid. In such embodiments, the multicomponent fibers may serve as a binder for the layer.

Non-limiting examples of suitable materials that may be included in multicomponent fibers include poly(olefin)s such as poly(ethylene), poly(propylene), and poly(butylene); poly(ester)s and co-poly(ester)s such as poly(ethylene terephthalate), co-poly(ethylene terephthalate), poly(butylene terephthalate), and poly(ethylene isophthalate); poly(amide)s and co-poly(amides) such as nylons and aramids; and halogenated polymers such as poly(tetrafluoroethylene). Suitable co-poly(ethylene terephthalate)s may comprise repeat units formed by the polymerization of ethylene terephthalate monomers and further comprise repeat units formed by the polymerization of one or more comonomers. Such comonomers may include linear, cyclic, and branched aliphatic dicarboxylic acids having 4-12 carbon atoms (e.g., butanedioic acid, pentanedioic acid, hexanedioic acid, dodecanedioic acid, and 1,4-cyclo-hexanedicarboxylic acid); aromatic dicarboxylic acids having 8-12 carbon atoms (e.g., isophthalic acid and 2,6-naphthalenedicarboxylic acid); linear, cyclic, and branched aliphatic diols having 3-8 carbon atoms (e.g., 1,3-propane diol, 1,2-propanediol, 1,4-butanediol, 3-methyl-1,5-pentanediol, 2,2-dimethyl-1,3-propanediol, 2-methyl-1,3-propanediol, and 1,4-cyclohexanediol); and/or aliphatic and aromatic/aliphatic ether glycols having 4-10 carbon atoms (e.g., hydroquinone bis(2-hydroxyethyl) ether and poly(ethylene ether) glycols having a molecular weight below 460 g/mol, such as diethylene ether glycol).

Co-poly(ethylene terephthalate)s may include repeat units formed by polymerization of comonomers (e.g., monomers other than ethylene glycol and terephthalic acid) in a variety of suitable amounts. For instance, a co-poly(ethylene terephthalate) may be formed from a mixture of monomers in which the comonomer may make up greater than or equal to 0.5 mol %, greater than or equal to 0.75 mol %, greater than or equal to 1 mol %, greater than or equal to 1.5 mol %, greater than or equal to 2 mol %, greater than or equal to 3 mol %, greater than or equal to 5 mol %, greater than or equal to 7.5 mol %, greater than or equal to 10 mol %, or greater than or equal to 12.5 mol % of the total amount of monomers. The co-poly(ethylene terephthalate) may be formed from a mixture of monomers in which the comonomer makes up less than or equal to 15 mol %, less than or equal to 12.5 mol %, less than or equal to 10 mol %, less than or equal to 7.5 mol %, less than or equal to 5 mol %, less than or equal to 3 mol %, less than or equal to 2 mol %, less than or equal to 1.5 mol %, less than or equal to 1 mol %, or less than or equal to 0.75 mol % of the total amount of monomers. Combinations of the above-referenced ranges are also possible (e.g., greater than or equal to 0.5 mol % and less than or equal to 15 mol %). Other ranges are also possible.

In embodiments in which a co-poly(ethylene terephthalate) comprises two or more types of repeat units formed by polymerization of a comonomer, each type of repeat unit may independently make up a mol % of the total amount of monomers from which the co-poly(ethylene terephthalate) is formed in one or more of the ranges described above and/or all of the comonomers together may make up a mol % of the total amount of monomers from which the co-poly(ethylene terephthalate) is formed in one or more of the ranges described above.

Non-limiting examples of suitable pairs of materials that may be included in bicomponent fibers include poly(ethylene)/poly(ethylene terephthalate), poly(propylene)/poly(ethylene terephthalate), co-poly(ethylene terephthalate)/poly(ethylene terephthalate), poly(butylene terephthalate)/poly(ethylene terephthalate), co-poly(amide)/poly(amide), and poly(ethylene)/poly(propylene). In the preceding list, the material having the lower melting temperature is listed first and the material having the higher melting temperature is listed second. Core-sheath bicomponent fibers comprising one of the above such pairs may have a sheath comprising the first material and a core comprising the second material.

In embodiments in which a layer comprises two or more types of bicomponent fibers, each type of bicomponent fiber may independently comprise one of the pairs of materials described above.

The multicomponent fibers described herein may comprise components having a variety of suitable melting points. In some embodiments, a multicomponent fiber comprises a component having a melting point of greater than or equal to 80° C., greater than or equal to 90° C., greater than or equal to 100° C., greater than or equal to 110° C., greater than or equal to 120° C., greater than or equal to 130° C., greater than or equal to 140° C., greater than or equal to 150° C., greater than or equal to 160° C., greater than or equal to 170° C., greater than or equal to 180° C., greater than or equal to 190° C., greater than or equal to 200° C., greater than or equal to 210° C., or greater than or equal to 220° C. In some embodiments, a multicomponent fiber comprises a component having a melting point less than or equal to 230° C., less than or equal to 220° C., less than or equal to 210° C., less than or equal to 200° C., less than or equal to 190° C., less than or equal to 180° C., less than or equal to 170° C., less than or equal to 160° C., less than or equal to 150° C., less than or equal to 140° C., less than or equal to 130° C., less than or equal to 120° C., less than or equal to 110° C., less than or equal to 100° C., or less than or equal to 90° C. Combinations of the above-referenced ranges are also possible (e.g., greater than or equal to 80° C. and less than or equal to 230° C., or greater than or equal to 110° C. and less than or equal to 230° C.). Other ranges are also possible. In some embodiments, a multicomponent fiber comprises a component having a melting point of less than or equal to 100° C. The melting point of the components of a multicomponent fiber may be determined by performing differential scanning calorimetry. The differential scanning calorimetry measurement may be carried out by heating the multicomponent fiber to 300° C. at 20° C./minute, cooling the multicomponent fiber to room temperature, and then determining the melting point during a reheating to 300° C. at 20° C./minute.

When present, multicomponent fibers may be included in a layer comprising adsorptive particles in a variety of suitable amounts. In some embodiments, multicomponent fibers make up greater than or equal to 6 wt %, greater than or equal to 7 wt %, greater than or equal to 8 wt %, greater than or equal to 10 wt %, greater than or equal to 12.5 wt %, greater than or equal to 15 wt %, or greater than or equal to 17.5 wt % of a layer comprising adsorptive particles. In some embodiments, multicomponent fibers make up less than or equal to 20 wt %, less than or equal to 17.5 wt %, less than or equal to 15 wt %, less than or equal to 12.5 wt %, less than or equal to 10 wt %, less than or equal to 8 wt %, or less than or equal to 7 wt % of a layer comprising adsorptive particles. Combinations of the above-referenced ranges are also possible (e.g., greater than or equal to 6 wt % and less than or equal to 20 wt %). Other ranges are also possible.

In embodiments in which a layer comprising adsorptive particles comprises two or more types of multicomponent fibers, each type of multicomponent fibers may independently be present in the layer in one or more of the ranges described above. In some embodiments, all of the multicomponent fibers in a layer comprising adsorptive particles together make up an amount of the layer in one or more of the ranges described above.

When present, multicomponent fibers may have a variety of suitable average diameters. In some embodiments, a layer comprising adsorptive particles comprises multicomponent fibers having an average diameter of greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, or greater than or equal to 30 microns. In some embodiments, a layer comprising adsorptive particles comprises multicomponent fibers having an average diameter of less than or equal to 32.5 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, or less than or equal to 12.5 microns. Combinations of the above-referenced ranges are also possible (e.g., greater than or equal to 10 microns and less than or equal to 32.5 microns). Other ranges are also possible.

In embodiments in which a layer comprising adsorptive particles comprises two or more types of multicomponent fibers, each type of multicomponent fibers may independently have an average diameter in one or more of the ranges described above. In some embodiments, all of the multicomponent fibers in a layer comprising adsorptive particles together have an average diameter in one or more of the ranges described above.

When present, multicomponent fibers may have a variety of suitable deniers. In some embodiments, a layer comprising adsorptive particles comprises multicomponent fibers having a denier of greater than or equal to 0.9, greater than or equal to 1, greater than or equal to 1.25, greater than or equal to 1.5, greater than or equal to 1.75, greater than or equal to 2, greater than or equal to 2.5, greater than or equal to 3, greater than or equal to 3.5, greater than or equal to 4, greater than or equal to 4.5, greater than or equal to 5, or greater than or equal to 5.5. In some embodiments, a layer comprising adsorptive particles comprises multicomponent fibers having a denier of less than or equal to 6, less than or equal to 5.5, less than or equal to 5, less than or equal to 4.5, less than or equal to 4, less than or equal to 3.5, less than or equal to 3, less than or equal to 2.5, less than or equal to 2, less than or equal to 1.75, less than or equal to 1.5, less than or equal to 1.25, or less than or equal to 1. Combinations of the above-referenced ranges are also possible (e.g., greater than or equal to 0.9 and less than or equal to 6). Other ranges are also possible.

In embodiments in which a layer comprising adsorptive particles comprises two or more types of multicomponent fibers, each type of multicomponent fibers may independently have a denier in one or more of the ranges described above. In some embodiments, all of the multicomponent fibers in a layer comprising adsorptive particles together have a denier in one or more of the ranges described above.

In some embodiments, a layer comprising adsorptive particles further comprises an adhesive. The adhesive may bond the adsorptive particles together. In other words, it may serve as a binder for the layer. One example of a suitable adhesive is a poly(urethane) hot-melt adhesive. This adhesive may initially be provided as an uncross-linked material that cross-links upon exposure to moisture (e.g., water vapor). The final layer comprising adsorptive particles may comprise the adhesive in a cross-linked form. Prior to cross-linking, the adhesive may have a viscosity of greater than or equal to 3500 Pa·s and less than or equal to 8000 Pa·s. This viscosity may be determined at 120° C. by use of a Brookfield Viscometer with a 27 spindle and at a shear rate of 20 min⁻¹. Further non-limiting examples of suitable adhesives include acrylics, poly(urethane)s, poly(olefin)s, poly(ester)s, poly(amide)s, poly(urea)s, and copolymers thereof. Such adhesives may also be hot-melt adhesives and/or may be cross-linkable. It is also possible for such adhesives to be supplied as a dispersion from which a solvent evaporates after application of the dispersion to produce a final, solid adhesive.

When present, adhesive may be included in a layer comprising adsorptive particles in a variety of suitable amounts. In some embodiments, an adhesive makes up greater than or equal to 5 wt %, greater than or equal to 6 wt %, greater than or equal to 7 wt %, greater than or equal to 8 wt %, greater than or equal to 10 wt %, greater than or equal to 12.5 wt %, greater than or equal to 15 wt %, greater than or equal to 17.5 wt %, greater than or equal to 20 wt %, greater than or equal to 22.5 wt %, greater than or equal to 25 wt %, greater than or equal to 30 wt %, or greater than or equal to 35 wt % of a layer comprising adsorptive particles. In some embodiments, an adhesive makes up less than or equal to 40 wt %, less than or equal to 35 wt %, less than or equal to 30 wt %, less than or equal to 25 wt %, less than or equal to 22.5 wt %, less than or equal to 20 wt %, less than or equal to 17.5 wt %, less than or equal to 15 wt %, less than or equal to 12.5 wt %, less than or equal to 10 wt %, less than or equal to 8 wt %, less than or equal to 7 wt %, or less than or equal to 6 wt % of a layer comprising adsorptive particles. Combinations of the above-referenced ranges are also possible (e.g., greater than or equal to 5 wt % and less than or equal to 40 wt %, or greater than or equal to 7 wt % and less than or equal to 20 wt %). Other ranges are also possible.

In embodiments in which a layer comprising adsorptive particles comprises two or more types of adhesives, each type of adhesive may independently be present in the layer comprising adsorptive particles in one or more of the ranges described above. In some embodiments, all of adhesive in a layer together makes up an amount of the layer comprising adsorptive particles in one or more of the ranges described above.

In some embodiments, a layer comprising adsorptive particles is non-fibrous. In other words, it may lack fibers and/or comprise fibers in relatively small amounts. In such embodiments, the adsorptive particles may be bound together and/or held in the layer by components other than fibers. For instance, the adsorptive particles may be bound together and/or held in the layer by adhesive and/or a melted component of a multicomponent fiber. It is also possible for a component binding adsorptive particles together and/or holding them in a layer to also adhere them to a layer to which they are adjacent (e.g., a support layer).

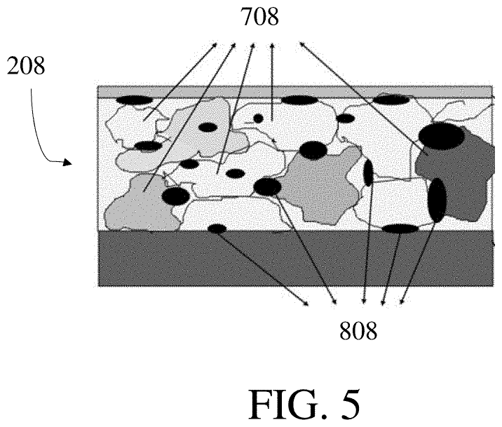

FIG. 5 shows one non-limiting example of a layer comprising adsorptive particles and lacking fibers positioned between two other layers. In FIG. 5, the layer 208 comprises a plurality of adsorbent particles 708 and an adhesive 808. It is also possible for a layer comprising adsorptive particles to have a morphology similar to that of FIG. 5, but in which a melted component of a multicomponent fiber bonds the adsorptive particles together instead of the adhesive shown in FIG. 5. In either case, it is apparent that, in some embodiments, the material binding the adsorptive particles together is not fibrous. Instead, this material may have another morphology (e.g., it may comprise globules, as is shown in FIG. 5, or it may have another suitable non-fibrous morphology).

When present, a material binding together adsorptive particles may have one or more similarities to the adhesive shown in FIG. 5 and/or may differ from the adhesive shown in FIG. 5 in one or more ways. For instance, the material binding together the adsorptive particles may have a relatively uniform morphology throughout the layer (e.g., it may comprise particles of a relatively uniform size) or may comprise components that differ across the layer (e.g., it may comprise particles of varying size). As another example, the material binding together the adsorptive particles may have a relatively uniform density across the layer or may be distributed across the layer such that some regions of the layer are richer in the material in comparison to other regions of the layer. As a third example, the relative size of a material binding together adsorptive particles with respect to the adsorptive particles may be similar to the relative size of the adhesive to the adsorptive particles shown in FIG. 5 or may differ from the relative size of the adhesive to the adsorptive particles shown in FIG. 5

Similarly, a layer may comprise adsorptive particles similar to the adsorptive particles shown in FIG. 5 in one or more ways and/or different from the adsorptive particles shown in FIG. 5 in one or more ways. For instance, the particles may have a morphology similar to those shown in FIG. 5 or may differ in shape from those shown in FIG. 5. As another example, the adsorptive particles may have a size and/or shape uniformity similar to the adsorptive particles shown in FIG. 5 or may be more or less uniform than the adsorptive particles shown in FIG. 5. As a third example, the adsorptive particles may have a relatively uniform density across the layer or may be distributed across the layer such that some regions of the layer are richer in the adsorptive particles in comparison to other regions of the layer.

In some embodiments, fibers make up less than or equal to 20 wt %, less than or equal to 17.5 wt %, less than or equal to 15 wt %, less than or equal to 12.5 wt %, less than or equal to 10 wt %, less than or equal to 8 wt %, less than or equal to 6 wt %, less than or equal to 4 wt %, less than or equal to 2 wt %, or less than or equal to 1 wt % of a layer comprising adsorptive particles. In some embodiments, fibers make up greater than or equal to 0 wt %, greater than or equal to 1 wt %, greater than or equal to 2 wt %, greater than or equal to 4 wt %, greater than or equal to 6 wt %, greater than or equal to 8 wt %, greater than or equal to 10 wt %, greater than or equal to 12.5 wt %, greater than or equal to 15 wt %, or greater than or equal to 17.5 wt % of a layer comprising adsorptive particles. Combinations of the above-referenced ranges are also possible (e.g., less than or equal to 20 wt % and greater than or equal to 0 wt %, or less than or equal to 20 wt % and greater than or equal to 6 wt %). Other ranges are also possible. In some embodiments, fibers make up 0 wt % of the layer comprising adsorptive particles (i.e., the layer comprising adsorptive particles is non-fibrous).

In embodiments in which a layer comprises two or more types of fibers, each type of fiber may independently be present in one or more of the ranges described above. In some embodiments, all of the fibers in a layer together have are present in one or more of the ranges described above.

When present, a layer comprising adsorptive particles may have a relatively high adsorption efficiency. In some embodiments, a filter media comprises a layer comprising adsorptive particles that has an adsorption efficiency of greater than or equal to 0%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 17.5%, greater than or equal to 20%, greater than or equal to 25%, greater than or equal to 30%, greater than or equal to 35%, greater than or equal to 40%, greater than or equal to 45%, greater than or equal to 50%, greater than or equal to 60%, or greater than or equal to 80%. In some embodiments, a filter media comprises a layer comprising adsorptive particles that has an adsorption efficiency of less than or equal to 100%, less than or equal to 80%, less than or equal to 60%, less than or equal to 50%, less than or equal to 45%, less than or equal to 40%, less than or equal to 35%, less than or equal to 30%, less than or equal to 25%, less than or equal to 20%, less than or equal to 17.5%, less than or equal to 15%, less than or equal to 12.5%, less than or equal to 10%, less than or equal to 7.5%, less than or equal to 5%, less than or equal to 2%, or less than or equal to 1%. Combinations of the above-referenced ranges are also possible (e.g., greater than or equal to 0% and less than or equal to 30%, greater than or equal to 0% and less than or equal to 50%, or greater than or equal to 0% and less than or equal to 100%). Other ranges are also possible. The adsorption efficiency of a layer comprising adsorptive particles may be measured in accordance with ISO 11155-2 (2009).

In embodiments in which a layer comprises two or more types of adsorptive particles, each type of adsorptive particles may independently have an adsorption efficiency for one or more species (e.g., volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases)) in one or more of the ranges described above. In some embodiments, all of the adsorptive particles in a layer together have an adsorption efficiency for one or more species (e.g., volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases)) in one or more of the ranges described above.

When present, a layer comprising adsorptive particles may exhibit a relatively low break through for one or more species. In some embodiments, the break through is less than or equal to 90%, less than or equal to 80%, less than or equal to 70%, less than or equal to 60%, less than or equal to 50%, less than or equal to 40%, less than or equal to 30%, or less than or equal to 20% for one or more species. In some embodiments, the break through is greater than or equal to 10%, greater than or equal to 20%, greater than or equal to 30%, greater than or equal to 40%, greater than or equal to 50%, greater than or equal to 60%, greater than or equal to 70%, or greater than or equal to 80% for one or more species. Combinations of the above-referenced ranges are also possible (e.g., less than or equal to 90% and greater than or equal to 10%). Other ranges are also possible.

The layers comprising adsorptive particles may have a break-through in one or more of the ranges in the preceding paragraph for one or more of the following species: volatile organic compounds (e.g., toluene, n-butane, SO₂, NOₓ), benzene, aldehydes (e.g., acetaldehyde, formaldehyde), acidic gases (e.g., H₂S, HCl, HF, HCN), basic gases (e.g., ammonia, amines such as trimethylamine and/or triethylamine), H₂, CO, N₂, sulfur, hydrocarbons, alcohols, O₃, water, and gaseous chemical weapons (e.g., nerve agents, mustard gases).

The break through of a layer comprising adsorptive particles for any particular species is the percentage of that species that passes through the layer comprising adsorptive particles. This may be determined in accordance with ISO 11155-2 (2009) on a flat sheet sample of the layer. Briefly, the method comprises: (1) drying the flat sheet at 60° C. in a drying cabinet until the filter mass is observed to have a mass that is stable to ±2%; (2) conditioning the flat sheet in a climactic chamber at 23° C. and at a relative humidity of 50% for 14 hours; (3) placing the filter media on a test stand and exposing it to clean air for 15 minutes; (4) exposing the flat sheet to a flow of air having 40% relative humidity and comprising the relevant species (i.e., the species whose break through is being assessed) and then measuring the amount of the relevant species in the flow of air after passing through the flat sheet by use of a gas analyzer. The air flow may have a face velocity of 20 cm/s and a temperature of 23° C. The measurement may be made until the concentration of the relevant species in the air after passing through the flat sheet is 95% of the concentration of the relevant species in the air prior to passing through the flat sheet or for a predetermined time. Unless otherwise specified, the measurement is performed for 0 minutes (i.e., the point in time at which the flow has reached steady-state through the flat sheet) and the concentration of the relevant species in the flow of air prior to passing through the flat sheet is 80 ppm. Specifically, for the ranges above, the measurement time is 0 minutes and the concentration of the relevant species in the flow of air prior to passing through the flat sheet 80 ppm. The break through is equal to 100% multiplied by the ratio of the amount of the relevant species in the air that passed through the flat sheet (in ppm) to the initial amount of the relevant species in the air prior to passing through the flat sheet (in ppm).

When present, a layer comprising adsorptive particles may be able to provide relatively high values of cumulate clean mass from a fluid initially comprising formaldehyde. For instance, the layer comprising adsorptive particles may have a grade of F1 (i.e., it may be capable of providing a cumulate clean mass of greater than or equal to 300 mg per weight of layer comprising adsorptive particles in mg and less than 600 mg per weight of layer comprising adsorptive particles in mg), F2 (i.e., it may be capable of providing a cumulate clean mass of greater than or equal to 600 mg per weight of layer comprising adsorptive particles in mg and less than 1 g per weight of layer comprising adsorptive particles in mg), F3 (i.e., it may be capable of providing a cumulate clean mass of greater than or equal to 1 g per weight of layer comprising adsorptive particles in mg and less than 1.5 g per weight of layer comprising adsorptive particles in mg), or F4 (i.e., it may be capable of providing a cumulate clean mass of greater than or equal to 1.5 g per weight of layer comprising adsorptive particles in mg). The rating of the layer may be determined in accordance with GB/T 18801-2015. Briefly, this process comprises injecting formaldehyde gas at 20 mg/hour into a 3 m³ chamber comprising the layer, recording the concentration of formaldehyde in the chamber every five minutes until one hour has elapsed, and then multiplying the rate of formaldehyde adsorption by the formaldehyde flow rate.

When present, a layer comprising adsorptive particles may be able to provide relatively high values of cumulate clean mass from a fluid initially comprising benzene. For instance, the layer comprising adsorptive particles may have a grade of B1 (i.e., it may be capable of providing a cumulate clean mass of greater than or equal to 300 mg per weight of layer comprising adsorptive particles in mg and less than 600 mg per weight of layer comprising adsorptive particles in mg), B2 (i.e., it may be capable of providing a cumulate clean mass of greater than or equal to 600 mg per weight of layer comprising adsorptive particles in mg and less than 1 g per weight of layer comprising adsorptive particles in mg), B3 (i.e., it may be capable of providing a cumulate clean mass of greater than or equal to 1 g per weight of layer comprising adsorptive particles in mg and less than 1.5 g per weight of layer comprising adsorptive particles in mg), or B4 (i.e., it may be capable of providing a cumulate clean mass of greater than or equal to 1.5 g per weight of layer comprising adsorptive particles in mg). The rating of the layer may be determined in accordance with GB/T 18801-2015. Briefly, this process comprises injecting benzene gas at 20 mg/hour into a 3 m³ chamber comprising the layer, recording the concentration of benzene in the chamber every five minutes until one hour has elapsed, and then multiplying the rate of benzene adsorption by the benzene flow rate.

When present, a layer comprising adsorptive particles may have a relatively high clean air delivery rate from a fluid initially comprising formaldehyde. The clean air delivery rate from a fluid initially comprising formaldehyde may be greater than or equal to 10 m³/hour, greater than or equal to 20 m³/hour, greater than or equal to 50 m³/hour, greater than or equal to 75 m³/hour, greater than or equal to 100 m³/hour, greater than or equal to 150 m³/hour, greater than or equal to 200 m³/hour, greater than or equal to 250 m³/hour, greater than or equal to 300 m³/hour, greater than or equal to 400 m³/hour, greater than or equal to 500 m³/hour, or greater than or equal to 600 m³/hour. The clean air delivery rate from a fluid initially comprising formaldehyde may be less than or equal to 700 m³/hour, less than or equal to 600 m³/hour, less than or equal to 500 m³/hour, less than or equal to 400 m³/hour, less than or equal to 300 m³/hour, less than or equal to 250 m³/hour, less than or equal to 200 m³/hour, less than or equal to 150 m³/hour, less than or equal to 100 m³/hour, less than or equal to 75 m³/hour, less than or equal to 50 m³/hour, or less than or equal to 20 m³/hour. Combinations of the above-referenced ranges are also possible (e.g., greater than or equal to 10 m³/hour and less than or equal to 700 m³/hour). Other ranges are also possible.

The clean air delivery rate from a fluid initially comprising formaldehyde for a layer comprising adsorptive particles may be determined in accordance with GB/T 18801-2015. Briefly, this process comprises: (1) pumping 1 mg/m³ of formaldehyde into a 1 m³ closed chamber containing the layer comprising adsorptive particles and then measuring the concentration of formaldehyde every 5 minutes for 60 minutes; (2) pumping 1 mg/m³ of formaldehyde into a 1 m³ closed chamber lacking the layer comprising adsorptive particles and then measuring the concentration of formaldehyde every 5 minutes for 60 minutes; (3) identifying the difference between the formaldehyde removed from the chamber containing the layer comprising adsorptive particles and the formaldehyde removed from the chamber lacking the layer comprising adsorptive particles as the volume of formaldehyde removed; and (4) dividing the volume of formaldehyde removed by 60 minutes to yield the clean air delivery rate.

When present, a layer comprising adsorptive particles may have a relatively high clean air delivery rate from a fluid initially comprising benzene. The clean air delivery rate from a fluid initially comprising benzene may be greater than or equal to 10 m³/hour, greater than or equal to 20 m³/hour, greater than or equal to 50 m³/hour, greater than or equal to 75 m³/hour, greater than or equal to 100 m³/hour, greater than or equal to 150 m³/hour, greater than or equal to 200 m³/hour, greater than or equal to 250 m³/hour, greater than or equal to 300 m³/hour, greater than or equal to 400 m³/hour, greater than or equal to 500 m³/hour, or greater than or equal to 600 m³/hour. The clean air delivery rate from a fluid initially comprising benzene may be less than or equal to 700 m³/hour, less than or equal to 600 m³/hour, less than or equal to 500 m³/hour, less than or equal to 400 m³/hour, less than or equal to 300 m³/hour, less than or equal to 250 m³/hour, less than or equal to 200 m³/hour, less than or equal to 150 m³/hour, less than or equal to 100 m³/hour, less than or equal to 75 m³/hour, less than or equal to 50 m³/hour, or less than or equal to 20 m³/hour. Combinations of the above-referenced ranges are also possible (e.g., greater than or equal to 10 m³/hour and less than or equal to 700 m³/hour). Other ranges are also possible.

The clean air delivery rate from a fluid initially comprising benzene for a layer comprising adsorptive particles may be determined in accordance with GB/T 18801-2015. Briefly, this process comprises: (1) pumping 1 mg/m³ of benzene into a 1 m³ closed chamber containing the layer comprising adsorptive particles and then measuring the concentration of benzene every 5 minutes for 60 minutes; (2) pumping 1 mg/m³ of benzene into a 1 m³ closed chamber lacking the layer comprising adsorptive particles and then measuring the concentration of benzene every 5 minutes for 60 minutes; (3) identifying the difference between the benzene removed from the chamber containing the layer comprising adsorptive particles and the benzene removed from the chamber lacking the layer comprising adsorptive particles as the volume of benzene removed; and (4) dividing the volume of benzene removed by 60 minutes to yield the clean air delivery rate.

When present, a layer comprising adsorptive particles may have a variety of suitable basis weights. In some embodiments, a layer comprising adsorptive particles has a basis weight of greater than or equal to 120 g/m², greater than or equal to 150 g/m², greater than or equal to 175 g/m², greater than or equal to 200 g/m², greater than or equal to 225 g/m², greater than or equal to 250 g/m², greater than or equal to 300 g/m², greater than or equal to 400 g/m², greater than or equal to 500 g/m², greater than or equal to 600 g/m², greater than or equal to 700 g/m², greater than or equal to 800 g/m², greater than or equal to 900 g/m², greater than or equal to 1000 g/m², greater than or equal to 1100 g/m², greater than or equal to 1200 g/m², greater than or equal to 1500 g/m², or greater than or equal to 1750 g/m². In some embodiments, a layer comprising adsorptive particles has a basis weight of less than or equal to 2000 g/m², less than or equal to 1750 g/m², less than or equal to 1500 g/m², less than or equal to 1200 g/m², less than or equal to 1100 g/m², less than or equal to 1000 g/m², less than or equal to 900 g/m², less than or equal to 800 g/m², less than or equal to 700 g/m², less than or equal to 600 g/m², less than or equal to 500 g/m², less than or equal to 400 g/m², less than or equal to 300 g/m², less than or equal to 250 g/m², less than or equal to 225 g/m², less than or equal to 200 g/m², less than or equal to 175 g/m², or less than or equal to 150 g/m². Combinations of the above-referenced ranges are also possible (e.g., greater than or equal to 120 g/m² and less than or equal to 2000 g/m², or greater than or equal to 120 g/m² and less than or equal to 1100 g/m²). Other ranges are also possible. The basis weight of a layer comprising adsorptive particles may be determined in accordance with ISO 536:2012.

When present, a layer comprising adsorptive particles may have a variety of suitable thicknesses. In some embodiments, a layer comprising adsorptive particles has a thickness of greater than or equal to 0.5 mm, greater than or equal to 0.75 mm, greater than or equal to 1 mm, greater than or equal to 1.25 mm, greater than or equal to 1.5 mm, greater than or equal to 1.75 mm, greater than or equal to 2 mm, greater than or equal to 2.25 mm, greater than or equal to 2.5 mm, greater than or equal to 2.75 mm, greater than or equal to 3 mm, greater than or equal to 3.5 mm, greater than or equal to 4 mm, greater than or equal to 4.5 mm, greater than or equal to 5 mm, greater than or equal to 6 mm, or greater than or equal to 7 mm. In some embodiments, a layer comprising adsorptive particles has a thickness of less than or equal to 8 mm, less than or equal to 7 mm, less than or equal to 6 mm, less than or equal to 5 mm, less than or equal to 4.5 mm, less than or equal to 4 mm, less than or equal to 3.5 mm, less than or equal to 3 mm, less than or equal to 2.75 mm, less than or equal to 2.5 mm, less than or equal to 2.25 mm, less than or equal to 2 mm, less than or equal to 1.75 mm, less than or equal to 1.5 mm, less than or equal to 1.25 mm, less than or equal to 1 mm, or less than or equal to 0.75 mm. Combinations of the above-referenced ranges are also possible (e.g., greater than or equal to 0.5 mm and less than or equal to 8 mm, greater than or equal to 0.5 mm and less than or equal to 5 mm, or greater than or equal to 0.5 mm and less than or equal to 2.5 mm). Other ranges are also possible. The thickness of a layer comprising adsorptive particles may be determined in accordance with ASTM D1777 (2015) under an applied pressure of 0.8 kPa.

In some embodiments, a layer comprising adsorptive particles and a support layer on which it is disposed together have a thickness in one or more of the ranges in the preceding paragraph. In some embodiments, a layer comprising adsorptive particles has a thickness in one or more of the ranges in the preceding paragraph and it is disposed on a support layer. As described elsewhere herein, in some embodiments, a filter media comprises a nanofiber layer. The nanofiber layer may enhance the filtration performance of the filter media and/or may serve as an efficiency layer.

When present, a nanofiber layer may have a variety of suitable morphologies. In some embodiments, a nanofiber layer is a non-woven fiber web. For instance, the nanofiber layer may be an electrospun non-woven fiber web, a meltblown non-woven fiber web, a centrifugal spun non-woven fiber web, an electroblown spun non-woven fiber web, or a fibrillated spun non-woven fiber web.

The fibers present in the nanofiber layer may be of a variety of suitable types. In some embodiments, a nanofiber layer includes fibers comprising one or more of: poly(ether)-b-poly(amide), poly(sulfone), poly(amide)s (e.g., nylons, such as nylon 6), poly(ester)s (e.g., poly(caprolactone), poly(butylene terephthalate)), poly(urethane)s, poly(urea)s, acrylics, polymers comprising a side chain comprising a carbonyl functional group (e.g., poly(vinyl acetate), cellulose ester, poly(acrylamide)), poly(ether sulfone), poly(acrylic)s (e.g., poly(acrylonitrile), poly(acrylic acid)), fluorinated polymers (e.g., poly(vinylidene difluoride)), polyols (e.g., poly(vinyl alcohol)), poly(ether)s (e.g., poly(ethylene oxide)), poly(vinyl pyrrolidone), poly(allylamine), butyl rubber, poly(ethylene), polymers comprising a silane functional group, polymers comprising a thiol functional group, and polymers comprising a methylol functional group (e.g., phenolic polymers, melamine polymers, melamine-formaldehyde polymers, cross-linkable polymers comprising pendant methylol groups).

When present, a nanofiber layer may comprise fibers having a variety of suitable average fiber diameters. In some embodiments, a nanofiber layer comprises fibers having an average fiber diameter of greater than or equal to 0.04 microns, greater than or equal to 0.05 microns, greater than or equal to 0.06 microns, greater than or equal to 0.08 microns, greater than or equal to 0.1 micron, greater than or equal to 0.125 microns, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, or greater than or equal to 0.8 microns. In some embodiments, a nanofiber layer comprises fibers having an average fiber diameter of less than or equal to 1 micron, less than or equal to 0.8 microns, less than or equal to 0.6 microns, less than or equal to 0.5 microns, less than or equal to 0.4 microns, less than or equal to 0.3 microns, less than or equal to 0.25 microns, less than or equal to 0.2 microns, less than or equal to 0.15 microns, less than or equal to 0.125 microns, less than or equal to 0.1 microns, less than or equal to 0.08 microns, less than or equal to 0.06 microns, or less than or equal to 0.05 microns. Combinations of the above-referenced ranges are also possible (e.g., greater than or equal to 0.04 microns and less than or equal to 1 micron, greater than or equal to 0.05 microns and less than or equal to 1 micron, or greater than or equal to 0.08 microns and less than or equal to 0.3 microns). Other ranges are also possible.

When present, a nanofiber layer may have a variety of suitable basis weights. In some embodiments, a nanofiber layer has a basis weight of greater than or equal to 0.01 g/m², greater than or equal to 0.02 g/m², greater than or equal to 0.03 g/m², greater than or equal to 0.04 g/m², greater than or equal to 0.05 g/m², greater than or equal to 0.06 g/m², greater than or equal to 0.08 g/m², greater than or equal to 0.1 g/m², greater than or equal to 0.2 g/m², greater than or equal to 0.5 g/m², greater than or equal to 0.75 g/m², greater than or equal to 1 g/m², greater than or equal to 1.25 g/m², greater than or equal to 1.5 g/m², greater than or equal to 1.75 g/m², greater than or equal to 2 g/m², greater than or equal to 2.5 g/m², greater than or equal to 3 g/m², greater than or equal to 3.5 g/m², greater than or equal to 4 g/m², or greater than or equal to 4.5 g/m². In some embodiments, a nanofiber layer has a basis weight of less than or equal to 5 g/m², less than or equal to 4.5 g/m², less than or equal to 4 g/m², less than or equal to 3.5 g/m², less than or equal to 3 g/m², less than or equal to 2.5 g/m², less than or equal to 2 g/m², less than or equal to 1.75 g/m², less than or equal to 1.5 g/m², less than or equal to 1.25 g/m², less than or equal to 1 g/m², less than or equal to 0.75 g/m², less than or equal to 0.5 g/m², less than or equal to 0.2 g/m², less than or equal to 0.1 g/m², less than or equal to 0.08 g/m², less than or equal to 0.06 g/m², less than or equal to 0.05 g/m², less than or equal to 0.04 g/m², less than or equal to 0.03 g/m², or less than or equal to 0.02 g/m². Combinations of the above-referenced ranges are also possible (e.g., greater than or equal to 0.01 g/m² and less than or equal to 5 g/m², greater than or equal to 0.03 g/m² and less than or equal to 4 g/m², or greater than or equal to 0.05 g/m² and less than or equal to 2 g/m²). Other ranges are also possible.

When present, a nanofiber layer may have a variety of suitable thicknesses. In some embodiments, a nanofiber layer has a thickness of greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.6 microns, greater than or equal to 0.8 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 40 microns, greater than or equal to 50 microns, greater than or equal to 60 microns, or greater than or equal to 80 microns. In some embodiments, a nanofiber layer has a thickness of less than or equal to 100 microns, less than or equal to 80 microns, less than or equal to 60 microns, less than or equal to 50 microns, less than or equal to 40 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.8 microns, less than or equal to 0.6 microns, less than or equal to 0.5 microns, less than or equal to 0.4 microns, less than or equal to 0.3 microns, less than or equal to 0.25 microns, less than or equal to 0.2 microns, less than or equal to 0.15 microns, or less than or equal to 0.1 micron. Combinations of the above-referenced ranges are also possible (e.g., greater than or equal to 0.1 micron and less than or equal to 100 microns, greater than or equal to 0.2 microns and less than or equal to 50 microns, or greater than or equal to 0.5 microns and less than or equal to 10 microns). Other ranges are also possible. The thickness of a nanofiber layer may be determined by cross-sectional scanning electron microscopy.

When present, a nanofiber layer may have a variety of suitable solidities. In some embodiments, a nanofiber layer has a solidity of greater than or equal to 0.1%, greater than or equal to 0.2%, greater than or equal to 0.3%, greater than or equal to 0.4%, greater than or equal to 0.5%, greater than or equal to 0.6%, greater than or equal to 0.8%, greater than or equal to 1%, greater than or equal to 2%, greater than or equal to 5%, greater than or equal to 7.5%, greater than or equal to 10%, greater than or equal to 12.5%, greater than or equal to 15%, greater than or equal to 20%, or greater than or equal to 25%. In some embodiments, a nanofiber layer has a solidity of less than or equal to 30%, less than or equal to 25%, less than or equal to 20%, less than or equal to 15%, less than or equal to 12.5%, less than or equal to 10%, less than or equal to 7.5%, less than or equal to 5%, less than or equal to 2%, less than or equal to 1%, less than or equal to 0.8%, less than or equal to 0.6%, less than or equal to 0.5%, less than or equal to 0.4%, less than or equal to 0.3%, or less than or equal to 0.2%. Combinations of the above-referenced ranges are also possible (e.g., greater than or equal to 0.1% and less than or equal to 30%, greater than or equal to 0.5% and less than or equal to 20%, or greater than or equal to 1% and less than or equal to 10%). Other ranges are also possible.

The solidity of a nanofiber layer is equivalent to the percentage of the interior of the nanofiber layer occupied by solid material. One non-limiting way of determining solidity of a nanofiber layer is described in this paragraph, but other methods are also possible. The method described in this paragraph includes determining the basis weight and thickness of the nanofiber layer and then applying the following formula: solidity=[basis weight of the nanofiber layer/(density of the components forming the nanofiber layer·thickness of the nanofiber layer)]·100%. The density of the components forming the nanofiber layer is equivalent to the average density of the material or material(s) forming the components of the nanofiber layer (e.g., fibers, species employed to modify the surface of the nanofiber layer), which is typically specified by the manufacturer of each material. The average density of the materials forming the components of the nanofiber layer may be determined by: (1) determining the total volume of all of the components in the nanofiber layer; and (2) dividing the total mass of all of the components in the nanofiber layer by the total volume of all of the components in the nanofiber layer. If the mass and density of each component of the layer are known, the volume of all the components in the nanofiber layer may be determined by: (1) for each type of component, dividing the total mass of the component in the nanofiber layer by the density of the component; and (2) summing the volumes of each component. If the mass and density of each component of the nanofiber layer are not known, the volume of all the components in the nanofiber layer may be determined in accordance with Archimedes' principle.

When present, a nanofiber layer may have a variety of suitable air permeabilities. In some embodiments, a nanofiber layer has an air permeability of greater than or equal to 10 CFM, greater than or equal to 20 CFM, greater than or equal to 30 CFM, greater than or equal to 40 CFM, greater than or equal to 50 CFM, greater than or equal to 60 CFM, greater than or equal to 70 CFM, greater than or equal to 80 CFM, greater than or equal to 100 CFM, greater than or equal to 125 CFM, or greater than or equal to 150 CFM. In some embodiments, a nanofiber layer has an air permeability of less than or equal to 170 CFM, less than or equal to 150 CFM, less than or equal to 125 CFM, less than or equal to 100 CFM, less than or equal to 80 CFM, less than or equal to 60 CFM, less than or equal to 50 CFM, less than or equal to 40 CFM, less than or equal to 30 CFM, or less than or equal to 20 CFM. Combinations of the above-referenced ranges are also possible (e.g., greater than or equal to 10 CFM and less than or equal to 170 CFM, greater than or equal to 30 CFM and less than or equal to 80 CFM, or greater than or equal to 40 CFM and less than or equal to 70 CFM). Other ranges are also possible. The air permeability may be determined in accordance with ASTM D737-04 (2016) at a pressure of 125 Pa. As would be known to one of ordinary skill in the art, the unit CFM is equivalent to the unit cfm/sf or ft/min.

In some embodiments, a nanofiber layer comprises fibers that comprise oleophobic properties, comprises an oleophobic component, and/or is surface-modified. In some embodiments, the nanofiber layer comprises a coating (e.g., an oleophobic coating, an oleophobic component that is an oleophobic coating) and/or comprises a resin (e.g., an oleophobic resin, an oleophobic component that is an oleophobic resin). The coating process may involve chemical deposition techniques and/or physical deposition techniques. For instance, a coating process may comprise introducing resin or a material (e.g., an oleophobic component that is a resin or material) dispersed in a solvent or solvent mixture into a pre-formed fiber layer (e.g., a pre-formed fiber web formed by an electrospinning process). As an example, a pre-filter may be sprayed with a coating material (e.g., a water-based fluoroacrylate such as AGE 550D). Non-limiting examples of coating methods include the use of vapor deposition (e.g., chemical vapor deposition, physical vapor deposition), layer-by-layer deposition, wax solidification, self-assembly, sol-gel processing, the use of a slot die coater, gravure coating, screen coating, size press coating (e.g., employing a two roll-type or a metering blade type size press coater), film press coating, blade coating, roll-blade coating, air knife coating, roll coating, foam application, reverse roll coating, bar coating, curtain coating, champlex coating, brush coating, Bill-blade coating, short dwell-blade coating, lip coating, gate roll coating, gate roll size press coating, laboratory size press coating, melt coating, dip coating, knife roll coating, spin coating, powder coating, spray coating (e.g., electrospraying), gapped roll coating, roll transfer coating, padding saturant coating, saturation impregnation, chemical bath deposition, and solution deposition. Other coating methods are also possible. As described further elsewhere herein, the nanofiber layer may be charged or uncharged, and it should be understood that any of the techniques described herein may be used to form layers which are either charged or uncharged.

In some embodiments, a coating material may be applied to a nanofiber layer using a non-compressive coating technique. The non-compressive coating technique may coat the nanofiber layer, while not substantially decreasing its thickness. In other embodiments, a resin may be applied to the nanofiber layer using a compressive coating technique.

Other techniques include vapor deposition methods. Such methods include atmospheric pressure chemical vapor deposition (APCVD), low pressure chemical vapor deposition (LPCVD), metal-organic chemical vapor deposition (MOCVD), plasma assisted chemical vapor deposition (PACVD) or plasma enhanced chemical vapor deposition (PECVD), laser chemical vapor deposition (LCVD), photochemical vapor deposition (PCVD), chemical vapor infiltration (CVI), chemical beam epitaxy (CBE), electron beam assisted radiation curing, and atomic layer deposition. In physical vapor deposition (PVD), thin films (e.g., thin films comprising an oleophobic component) are deposited by the condensation of a vaporized form of the desired film material onto substrate. This method involves physical processes such as high-temperature vacuum evaporation with subsequent condensation, plasma sputter bombardment rather than a chemical reaction, electron beam evaporation, molecular beam epitaxy, and/or pulsed laser deposition.

In some embodiments, a surface of a nanofiber layer may be modified using additives (e.g., oleophobic components that are additives such as oleophobic additives). In some embodiments, a nanofiber layer comprises an additive or additives (e.g., oleophobic components that are additive(s) such as oleophobic additive(s)). The additives may be functional chemicals that are added to polymeric/thermoplastic fibers during an electrospinning process that may result in different physical and chemical properties at the surface from those of the polymer/thermoplastic itself after formation. For instance, the additive(s) may be added to an electrospinning solution used to form the nanofiber layer. The additive(s) may, in some embodiments, migrate towards the surface of the fibers during and/or after formation of the fibers such that the surface of the fiber is modified with the additive, with the center of the fiber including more of the polymer/thermoplastic material. In some embodiments, one or more additives are included to render the surface of a fiber oleophobic as described herein. For instance, the additive may be an oleophobic material as described herein. Non-limiting examples of suitable additives include fluoroacrylates, fluorosurfactants, oleophobic silicones, fluoropolymers, fluoromonomers, fluorooligomers, and oleophobic polymers.

The additive (e.g., the oleophobic component in the form of an additive), if present, may be present in any suitable form prior to undergoing an electrospinning procedure and/or in any suitable form in the fiber after fiber formation. For instance, in some embodiments, the additive may be in a liquid (e.g., melted) form that is mixed with a thermoplastic material prior to and/or during fiber formation. In some cases, the additive may be in particulate form prior to, during, and/or after fiber formation. In certain embodiments, particles of a melt additive may be present in the fully formed fibers. In some embodiments, an additive may be one component of a binder, and/or may be added to one or more layers by spraying the layer with a composition comprising the additive. If particulate, the additive may have any suitable morphology (e.g., particles of different shapes and sizes, flakes, ellipsoids, fibers).

In some embodiments, a material (e.g., an oleophobic component, a precursor that reacts to form an oleophobic component) undergoes a chemical reaction (e.g., polymerization) after being applied to a nanofiber layer. For example, a surface of a nanofiber layer may be coated with one or more monomers that is polymerized after coating. In another example, a surface of a nanofiber layer may include monomers, as a result of a melt additive, that are polymerized after formation of the nanofiber layer. In some such embodiments, an in-line polymerization may be used. In-line polymerization (e.g., in-line ultraviolet polymerization) is a process to cure a monomer or liquid polymer solution onto a substrate under conditions sufficient to induce polymerization (e.g., under UV irradiation).

The term “self-assembled monolayers” (SAMs) refers to molecular assemblies that may be formed spontaneously by the immersion of an appropriate substrate into a solution of an active surfactant in an organic solvent to create an oleophobic surface. In some embodiments, a surface modification comprises a SAM formed on one or more surfaces of the fibers in a nanofiber layer.

In wax solidification, the nanofiber layer is dipped into melted alkylketene dimer (AKD) heated at 90° C., and then cooled at room temperature in an atmosphere of dry N₂ gas. AKD undergoes fractal growth when it solidifies and improves the oleophobicity of the nanofiber layer. In some embodiments, a surface modification comprises a layer formed by wax solidification.

In some embodiments, a species used to form a surface-modified nanofiber layer or a species that is a component of a surface-modified nanofiber layer comprises a small molecule, such as an inorganic or organic oleophobic molecule. Non-limiting examples include hydrocarbons (e.g., CH₄, C₂H₂, C₂H₄, C₆H₆), fluorocarbons (e.g., fluoroaliphatic compounds, fluoroaromatic compounds, fluoropolymers, fluorocarbon block copolymers, fluorocarbon acrylate polymers, fluorocarbon methacrylate polymers, fluoroelastomers, fluorosilanes, fluorosiloxanes, fluoro polyhedral oligomeric silsesquioxane, fluorinated dendrimers, inorganic fluorine compounds, CF₄, C₂F₄, C₃F₆, C₃F₈, C₄H₈, C₅H₁₂, C₆F₆, SF₃, SiF₄, BF₃), silanes (e.g., SiH₄, Si₂H₆, Si₃H₈, Si₄H₁₀), organosilanes (e.g., methylsilane, dimethylsilane, triethylsilane), siloxanes (e.g., dimethylsiloxane, hexamethyldisiloxane), ZnS, CuSe, InS, CdS, tungsten, silicon carbide, silicon nitride, silicon oxynitride, titanium nitride, carbon, silicon-germanium, and hydrophobic acrylic monomers terminating with alkyl groups and their halogenated derivatives (e.g., ethyl 2-ethylacrylate, methyl methacrylate; acrylonitrile). In certain embodiments, suitable hydrocarbons for modifying a surface of a nanofiber layer have the formula CₓH_{y}, where x is an integer from 1 to 10 and y is an integer from 2 to 22. In certain embodiments, suitable silanes for modifying a surface of a nanofiber layer have the formula SiₙH₂ₙ₊₂ where any hydrogen may be substituted for a halogen (e.g., Cl, F, Br, I), and where n is an integer from 1 to 10. In some embodiments, a species used to form a surface-modified nanofiber layer or a species that is a component of a surface-modified nanofiber layer comprises one or more of a wax, a silicone, and a corn based polymer (e.g., Zein). In some embodiments, a species used to form a surface-modified nanofiber layer or a species that is a component of a surface-modified nanofiber layer may comprise one or more nano-particulate materials. Other compositions are also possible.

As used herein, “small molecules” refers to molecules, whether naturally occurring or artificially created (e.g., via chemical synthesis) that have a relatively low molecular weight. Typically, a small molecule is an organic compound (i.e., it contains carbon). The small organic molecule may contain multiple carbon-carbon bonds, stereocenters, and/or other functional groups (e.g., amines, hydroxyl, carbonyls, and heterocyclic rings, etc.). In certain embodiments, the molecular weight of a small molecule is at most 1,000 g/mol, at most 900 g/mol, at most 800 g/mol, at most 700 g/mol, at most 600 g/mol, at most 500 g/mol, at most 400 g/mol, at most 300 g/mol, at most 200 g/mol, or at most 100 g/mol. In certain embodiments, the molecular weight of a small molecule is at least 100 g/mol, at least 200 g/mol, at least 300 g/mol, at least 400 g/mol, at least 500 g/mol, at least 600 g/mol, at least 700 g/mol, at least 800 g/mol, at least 900 g/mol, or at least 1,000 g/mol. Combinations of the above ranges are also possible (e.g., at least 200 g/mol and at most 500 g/mol). Other ranges are also possible.

In some embodiments, a species used to form a surface-modified nanofiber layer or a species that is a component of a surface-modified nanofiber layer (e.g., an oleophobic component, a precursor that reacts to form an oleophobic component) comprises a cross-linker. Non-limiting examples of suitable cross-linkers include species with one or more acrylate groups, such as 1,6-hexanediol diacrylate, and alkoxylated cyclohexane dimethanol diacrylate.

In some embodiments, a surface of a nanofiber layer is modified by roughening the surface or material on the surface of the nanofiber layer. In some such cases, the surface modification may be a roughened surface or material. The surface roughness of the surface of a nanofiber layer or material on the surface of a layer may be roughened microscopically and/or macroscopically. Non-limiting examples of methods for enhancing roughness include modifying a surface with certain fibers, mixing fibers having different diameters, and lithography. In certain embodiments, fibers with different diameters (e.g., staple fibers, continuous fibers) may be mixed or used to enhance or decrease surface roughness. In some embodiments, electrospinning may be used to create applied surface roughness alone or in combination with other methods, such as chemical vapor deposition. In some embodiments, lithography may be used to roughen a surface. Lithography encompasses many different types of surface preparation in which a design is transferred from a master onto a surface.

In some embodiments, the roughness of a nanofiber layer may be used to modify the wettability of the nanofiber layer with respect to a particular fluid. In some instances, the roughness may alter or enhance the wettability of a surface of a nanofiber layer. In some cases, roughness may be used to enhance the oleophobicity of an intrinsically oleophobic surface.

Some nanofiber layers that are oleophobic may have an oil rank of greater than or equal to 1. The oil rank may be due to fibers within the layer that intrinsically have an oil rank greater than or equal to 1 (e.g., poly(tetrafluoroethylene) fibers), may be due to a surface modification that raises the oil rank of fibers within the layer having an initially lower oil rank, and/or may be due to an oleophobic component that raises the oil rank of the layer. In some embodiments, a nanofiber layer has an oil rank of greater than or equal to 1, greater than or equal to 2, greater than or equal to 3, greater than or equal to 4, greater than or equal to 4.5, greater than or equal to 5, greater than or equal to 5.5, greater than or equal to 6, greater than or equal to 6.5, greater than or equal to 7, or greater than or equal to 7.5. In some embodiments, a nanofiber layer has an oil rank of less than or equal to 8, less than or equal to 7.5, less than or equal to 7, less than or equal to 6.5, less than or equal to 6, less than or equal to 5.5, less than or equal to 5, less than or equal to 4.5, less than or equal to 4, less than or equal to 3, or less than or equal to 2. Combinations of the above-referenced ranges are also possible (e.g., greater than or equal to 1 and less than or equal to 8, greater than or equal to 1 and less than or equal to 8, greater than or equal to 1 and less than or equal to 6, or greater than or equal to 5 and less than or equal to 6). Other ranges are also possible.

Oil rank may be determined according to AATCC TM 118 (1997) measured at 23° C. and 50% relative humidity (RH). Briefly, 5 drops of each test oil (having an average droplet diameter of about 2 mm) are placed on five different locations on the surface of the nanofiber layer. The test oil with the greatest oil surface tension that does not wet the surface of the fiber web (e.g., has a contact angle greater than or equal to 90 degrees with the surface) after 30 seconds of contact with the fiber web at 23° C. and 50% RH, corresponds to the oil rank (listed in Table 2). For example, if a test oil with a surface tension of 26.6 mN/m does not wet (i.e., has a contact angle of greater than or equal to 90 degrees with the surface) the surface of the nanofiber layer after 30 seconds, but a test oil with a surface tension of 25.4 mN/m wets the surface of the nanofiber layer within thirty seconds, the nanofiber layer has an oil rank of 4. By way of another example, if a test oil with a surface tension of 25.4 mN/m does not wet the surface of the nanofiber layer after 30 seconds, but a test oil with a surface tension of 23.8 mN/m wets the surface of the nanofiber layer within thirty seconds, the nanofiber layer has an oil rank of 5. By way of yet another example, if a test oil with a surface tension of 23.8 mN/m does not wet the surface of the nanofiber layer after 30 seconds, but a test oil with a surface tension of 21.6 mN/m wets the surface of the nanofiber layer within thirty seconds, the nanofiber layer has an oil rank of 6. In some embodiments, if three of more of the five drops partially wet the surface (e.g., forms a droplet, but not a well-rounded drop on the surface) in a given test, then the oil rank is expressed to the nearest 0.5 value determined by subtracting 0.5 from the number of the test liquid. By way of example, if a test oil with a surface tension of 25.4 mN/m does not wet the surface of the nanofiber layer after 30 seconds, but a test oil with a surface tension of 23.8 mN/m only partially wets the surface of nanofiber layer after 30 seconds (e.g., three or more of the test droplets form droplets on the surface of the fiber web that are not well-rounded droplets) within thirty seconds, the nanofiber layer has an oil rank of 5.5.

TABLE 2

| Oil Rank | Test Oil | Surface Tension (mN/m) |
|---|---|---|
| 1 | Kaydol (mineral oil) | 31 |
| 2 | 65/35 Kaydol/n-hexadecane | 28 |
| 3 | n-hexadecane | 27.5 |
| 4 | n-tetradecane | 26.6 |
| 5 | n-dodecane | 25.4 |
| 6 | n-decane | 23.8 |
| 7 | n-octane | 21.6 |
| 8 | n-heptane | 20.1 |

It is also possible for nanofiber layers to comprise fibers that comprise hydrophobic properties, to comprise a hydrophobic component (e.g., a hydrophobic additive), and/or to be surface-modified to be hydrophobic. In some embodiments, the nanofiber layer comprises a hydrophobic coating and/or comprises a hydrophobic resin. For instance, in some embodiments, a nanofiber layer comprises fibers that are hydrophobic. Non-limiting examples of such fibers include poly(propylene) fibers and poly(vinylidene difluoride) fibers. In some embodiments, one or more of the techniques described above that enhance the oleophobicity of a nanofiber layer may also enhance its hydrophobicity. For instance, the presence of fluorinated species (e.g., fluoropolymers) and/or non-polar species (e.g., poly(olefin)s, waxes, silicon-based materials) in a nanofiber layer will enhance both its oleophobicity and hydrophobicity.

A nanofiber layer that is hydrophobic may have a water contact angle of greater than or equal to 90°, greater than or equal to 100°, greater than or equal to 110°, greater than or equal to 120°, greater than or equal to 130°, greater than or equal to 140°, or greater than or equal to 150°. A nanofiber layer that is hydrophobic may have a water contact angle of less than or equal to 160°, less than or equal to 150°, less than or equal to 140°, less than or equal to 130°, less than or equal to 120°, less than or equal to 110°, or less than or equal to 100°. Combinations of the above-referenced ranges are also possible (e.g., greater than or equal to 90° and less than or equal to 160°). Other ranges are also possible. The water contact angle may be determined by following the procedure described in ASTM D5946 (2009) and measuring the contact angle within 15 seconds of water application.

In some embodiments, a nanofiber layer comprises fibers that comprise hydrophilic properties, comprises a hydrophilic component (e.g., a hydrophilic additive), and/or is surface-modified to be hydrophilic. For instance, in some embodiments, a nanofiber layer comprises fibers that are hydrophilic. Non-limiting examples of such fibers include poly(amide) fibers (e.g., nylon fibers) and poly(ester) fibers. As another example, a prefilter may be surface-treated with a hydrophilic surfactant. Non-limiting examples of suitable such surfactants include alkylbenzene sulfonates (e.g., 4-(5-dodecyl)benzenesulfonate), fatty acids and their salts (e.g., sodium stearate), lauryl sulfate, di-alkyl sulfosuccinates (e.g., dioctyl sodium sulfosuccinate), lignosulfonates, alkyl ether phosphates, benzalkonium chloride, and perfluorooctanesulfonate.

A nanofiber layer that is hydrophilic may have a water contact angle of less than 90°, less than or equal to 80°, less than or equal to 70°, less than or equal to 60°, less than or equal to 50°, less than or equal to 40°, less than or equal to 30°, less than or equal to 20°, or less than or equal to 10°. A nanofiber layer that is hydrophilic may have a water contact angle of greater than or equal to 0°, greater than or equal to 10°, greater than or equal to 20°, greater than or equal to 30°, greater than or equal to 40°, greater than or equal to 50°, greater than or equal to 60°, greater than or equal to 70°, or greater than or equal to 80°. Combinations of the above-referenced ranges are also possible (e.g., less than 90° and greater than or equal to 0°). Other ranges are also possible. It is also possible for a nanofiber layer to be so hydrophilic that water applied thereto wicks into the layer and so does not form a droplet for which the contact angle can be measured. When such behavior is observed, the layer is assigned a contact angle of 0°. The water contact angle may be determined in accordance with ASTM D5946 (2009) described elsewhere herein with respect to the water contact angle of hydrophobic nanofiber layers.

In some embodiments, a nanofiber layer is charged. It is also possible for a filter media to comprise an uncharged nanofiber layer. When present, charge (e.g., electrostatic charge) may be induced on the nanofiber layer by a variety of suitable charging process, non-limiting examples of which include corona discharging (e.g., employing AC corona, employing DC corona), employing an ionic charge bar (e.g., powered by a positive current, powered by a negative current), tribocharging (e.g., hydrocharging, charging by fiber friction), and/or electrospinning (e.g., a filter media may comprise a charged electrospun non-woven fiber web that acquired its charge during electro spinning).

A hydro charging process may comprise impinging jets and/or streams of water droplets onto an initially uncharged nanofiber layer to cause it to become charged electrostatically. At the conclusion of the hydro charging process, the nanofiber layer may have an electret charge. The jets and/or streams of water droplets may impinge on the nanofiber layer at a variety of suitable pressures, such as a pressure of between 10 to 50 psi, and may be provided by a variety of suitable sources, such as a sprayer. In some embodiments, a nanofiber layer is hydro charged by using an apparatus that may be employed for the hydroentanglement of fibers which is operated at a lower pressure than is typical for the hydroentangling process. The water impinging on the nanofiber layer may be relatively pure; for instance, it may be distilled water and/or deionized water. After electrostatic charging in this manner, the nanofiber layer may be dried, such as with air dryer.

In some embodiments, a nanofiber layer is hydro charged while being moved laterally. The nanofiber layer may be transported on a porous belt, such as a screen or mesh-type conveyor belt. As it is being transported on the porous belt, it may be exposed to a spray and/or jets of water pressurized by a pump. The water jets and/or spray may impinge on the nanofiber layer and/or penetrate therein. In some embodiments, a vacuum is provided beneath the porous transport belt, which may aid the passage of water through the nanofiber layer and/or reduce the amount of time and energy necessary for drying the nanofiber layer at the conclusion of the hydro charging process.

A fiber friction charging process (also referred to as a triboelectric charging process) may comprise bringing into contact and then separating two surfaces, at least one of which is a surface at which fibers to be charged are positioned. This process may cause the transfer of charge between the two surfaces and the associated buildup of charge on the two surfaces. The surfaces may be selected such that they have sufficiently different positions in the triboelectric series to result in a desirable level of charge transfer therebetween upon contact.

As described elsewhere herein, in some embodiments, a filter media comprises a prefilter. The prefilter may comprise coarser fibers than the nanofiber layer and/or may serve to filter out larger particles from a fluid prior to exposure of the nanofiber layer to the fluid. This may advantageously reduce clogging of the nanofiber layer by such larger particles, thereby extending the lifetime of the filter media. It is also possible for the prefilters described herein to serve as capacity layers and/or to provide stiffness to the filter media that enhances the ease with which they are pleated. In some embodiments, a prefilter may serve to protect (e.g., mechanically) a relatively delicate nanofiber layer to which it is adjacent.

A variety of suitable types of layers may be employed as prefilters. In some embodiments, a prefilter is a fibrous layer. For instance, a prefilter may be a non-woven fiber web. Non-limiting examples of suitable non-woven fiber webs include meltblown non-woven fiber webs, spunbond non-woven fiber webs, carded non-woven fiber webs, and wetlaid non-woven fiber webs.

When present, a prefilter may comprise fibers having a variety of suitable average fiber diameters. In some embodiments, the average fiber diameter of the fibers in a prefilter is greater than or equal to 0.4 microns, greater than or equal to 0.5 microns, greater than or equal to 0.6 microns, greater than or equal to 0.8 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, or greater than or equal to 45 microns. In some embodiments, the average fiber diameter of the fibers in a prefilter is less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.8 microns, less than or equal to 0.6 microns, or less than or equal to 0.5 microns. Combinations of the above-referenced ranges are also possible (e.g., greater than or equal to 0.4 microns and less than or equal to 50 microns, greater than or equal to 0.5 microns and less than or equal to 30 microns, or greater than or equal to 1 micron and less than or equal to 20 microns). Other ranges are also possible.

In some embodiments, a prefilter comprises synthetic fibers. The synthetic fibers may make up greater than or equal to 1 wt %, greater than or equal to 2 wt %, greater than or equal to 5 wt %, greater than or equal to 7.5 wt %, greater than or equal to 10 wt %, greater than or equal to 12.5 wt %, greater than or equal to 15 wt %, greater than or equal to 20 wt %, greater than or equal to 25 wt %, greater than or equal to 30 wt %, greater than or equal to 35 wt %, greater than or equal to 40 wt %, greater than or equal to 45 wt %, greater than or equal to 50 wt %, greater than or equal to 60 wt %, greater than or equal to 70 wt %, greater than or equal to 80 wt %, or greater than or equal to 90 wt % of the prefilter. The synthetic fibers may make up less than or equal to 100 wt %, less than or equal to 90 wt %, less than or equal to 80 wt %, less than or equal to 70 wt %, less than or equal to 60 wt %, less than or equal to 50 wt %, less than or equal to 45 wt %, less than or equal to 40 wt %, less than or equal to 35 wt %, less than or equal to 30 wt %, less than or equal to 25 wt %, less than or equal to 20 wt %, less than or equal to 15 wt %, less than or equal to 12.5 wt %, less than or equal to 10 wt %, less than or equal to 7.5 wt %, less than or equal to 5 wt %, or less than or equal to 2 wt % of the prefilter. Combinations of the above-referenced ranges are also possible (e.g., greater than or equal to 1 wt % and less than or equal to 100 wt %, greater than or equal to 10 wt % and less than or equal to 100 wt %, or greater than or equal to 40 wt % and less than or equal to 100 wt %). Other ranges are also possible. In some embodiments, synthetic fibers make up 100 wt % of the prefilter.

In some embodiments, the average fiber diameter of synthetic fibers in a prefilter is greater than or equal to 0.4 microns, greater than or equal to 0.5 microns, greater than or equal to 0.6 microns, greater than or equal to 0.8 microns, greater than or equal to 1 micron, greater than or equal to 1.25 microns, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, greater than or equal to 8 microns, greater than or equal to 10 microns, greater than or equal to 12.5 microns, greater than or equal to 15 microns, greater than or equal to 17.5 microns, greater than or equal to 20 microns, greater than or equal to 22.5 microns, greater than or equal to 25 microns, greater than or equal to 27.5 microns, greater than or equal to 30 microns, greater than or equal to 35 microns, greater than or equal to 40 microns, or greater than or equal to 45 microns. In some embodiments, the average fiber diameter of synthetic fibers in a prefilter is less than or equal to 50 microns, less than or equal to 45 microns, less than or equal to 40 microns, less than or equal to 35 microns, less than or equal to 30 microns, less than or equal to 27.5 microns, less than or equal to 25 microns, less than or equal to 22.5 microns, less than or equal to 20 microns, less than or equal to 17.5 microns, less than or equal to 15 microns, less than or equal to 12.5 microns, less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1.25 microns, less than or equal to 1 micron, less than or equal to 0.8 microns, less than or equal to 0.6 microns, or less than or equal to 0.5 microns. Combinations of the above-referenced ranges are also possible (e.g., greater than or equal to 0.4 microns and less than or equal to 50 microns, greater than or equal to 0.5 microns and less than or equal to 30 microns, greater than or equal to 1 micron and less than or equal to 20 microns, or greater than or equal to 15 and less than or equal to 25 microns). Other ranges are also possible.

A prefilter may comprise synthetic staple fibers and/or may comprise synthetic continuous fibers. Continuous fibers may be made by a “continuous” fiber-forming process, such as a meltblown or a spunbond process, and typically have longer lengths than non-continuous fibers. Non-continuous fibers may be staple fibers that may be cut (e.g., from a filament) or formed as non-continuous discrete fibers to have a particular length or a range of lengths as described in more detail herein. In certain embodiments, a prefilter comprises continuous fibers that have an average length of greater than 5 inches.

When present, the synthetic staple fibers may have a variety of suitable lengths. In some embodiments, a prefilter comprises synthetic staple fibers having an average length of greater than or equal to 0.1 inch, greater than or equal to 0.15 inches, greater than or equal to 0.2 inches, greater than or equal to 0.25 inches, greater than or equal to 0.3 inches, greater than or equal to 0.4 inches, greater than or equal to 0.5 inches, greater than or equal to 0.6 inches, greater than or equal to 0.8 inches, greater than or equal to 1 inch, greater than or equal to 1.5 inches, greater than or equal to 2 inches, or greater than or equal to 3 inches. In some embodiments, a prefilter comprises synthetic staple fibers having an average length of less than or equal to 5 inches, less than or equal to 3 inches, less than or equal to 2 inches, less than or equal to 1.5 inches, less than or equal to 1 inch, less than or equal to 0.8 inches, less than or equal to 0.6 inches, less than or equal to 0.5 inches, less than or equal to 0.4 inches, less than or equal to 0.3 inches, less than or equal to 0.25 inches, less than or equal to 0.2 inches, or less than or equal to 0.15 inches. Combinations of the above-referenced ranges are also possible (e.g., greater than or equal to 0.1 inch and less than or equal to 5 inches, greater than or equal to 0.2 inches and less than or equal to 5 inches, or greater than or equal to 0.5 inches and less than or equal to 5 inches). Other ranges are also possible.

In some embodiments, a prefilter comprises monocomponent synthetic fibers. The monocomponent synthetic fibers may comprise a variety of materials, including poly(ester)s (e.g., poly(ethylene terephthalate), poly(butylene terephthalate)), poly(carbonate), poly(amide)s (e.g., various nylon polymers), poly(aramid)s, poly(imide)s, poly(olefin)s (e.g., poly(ethylene), poly(propylene)), poly(ether ether ketone), poly(acrylic)s (e.g., poly(acrylonitrile), dryspun poly(acrylic)), poly(vinyl alcohol), regenerated cellulose (e.g., synthetic cellulose such cellulose acetate, rayon), fluorinated polymers (e.g., poly(vinylidene difluoride) (PVDF)), copolymers of poly(ethylene) and PVDF, and poly(ether sulfone)s.

In some embodiments, a prefilter comprises two or more types of fibers. For instance, a prefilter may comprise two types of fibers having different dielectric constants. One example of a pair of such fibers is poly(propylene) fibers and acrylic fibers (e.g., wetspun acrylic fibers, modacrylic fibers, dryspun acrylic fibers). Another example of a pair of such fibers is poly(propylene) fibers and polyester fibers. The relative amounts of poly(propylene) fibers, acrylic fibers, and/or polyester fibers may generally be selected as desired. In some embodiments, the weight ratio of poly(propylene) fibers to acrylic fibers (e.g., dryspun acrylic fibers, modacrylic fibers) and/or polyester fibers is greater than or equal to 5:95, greater than or equal to 10:90, greater than or equal to 15:85, greater than or equal to 20:80, greater than or equal to 25:75, greater than or equal to 30:70, greater than or equal to 35:65, greater than or equal to 40:60, greater than or equal to 45:55, greater than or equal to 50:50, greater than or equal to 55:45, greater than or equal to 60:40, greater than or equal to 65:45, greater than or equal to 70:30, greater than or equal to 75:25, greater than or equal to 80:20, greater than or equal to 85:15, or greater than or equal to 90:10. In some embodiments, the weight ratio of poly(propylene) fibers to acrylic fibers (e.g., dryspun acrylic fibers, modacrylic fibers) and/or polyester fibers is less than or equal to 95:5, less than or equal to 90:10, less than or equal to 85:15, less than or equal to 80:20, less than or equal to 75:25, less than or equal to 70:30, less than or equal to 65:35, less than or equal to 60:40, less than or equal to 55:45, less than or equal to 50:50, less than or equal to 45:55, less than or equal to 35:65, less than or equal to 30:70, less than or equal to 25:75, less than or equal to 20:80, less than or equal to 15:85, or less than or equal to 10:90. Combinations of the above-referenced ranges are also possible (e.g., greater than or equal to 5:95 and less than or equal to 95:5, or greater than or equal to 30:70 and less than or equal to 70:30). Other ranges are also possible.

When present, the monocomponent synthetic fibers may make up a variety of suitable amounts of the prefilter. For instance, in some embodiments, a prefilter comprises monocomponent synthetic fibers in one or more of the amounts described above with respect to synthetic fibers.

In some embodiments, a prefilter comprises synthetic fibers that are multicomponent fibers. The multicomponent fibers may bond together one or more other types of fibers in the prefilter. When present, the multicomponent fibers may have a composition, a morphology, and/or one or more physical and/or chemical features similar to that described elsewhere herein with respect to the multicomponent fibers that may be present in a layer comprising adsorptive particles. Additionally, in some embodiments, a layer may comprise multicomponent fibers that initially had one of the structures described for the multicomponent fibers that may be present in a layer comprising adsorptive particles, but underwent a process (e.g., a splitting process) during fabrication of the filter media to form a different structure. By way of example, some prefilters may comprise fibers that were initially bicomponent fibers but were split during filter media fabrication (e.g., during fabrication of the prefilter) to form finer fibers. Such finer fibers may undergo hydroentangling on the production line before the prefilter is wound up and/or before any binding step is performed. The multicomponent fibers may make up a variety of suitable amounts of the prefilter. In some embodiments, a prefilter comprises multicomponent fibers in one or more of the amounts described above with respect to synthetic fibers.

In some embodiments, a prefilter comprises glass fibers. The glass fibers may make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the prefilter. In some embodiments, glass fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the prefilter. Combinations of the above-referenced ranges are also possible (e.g., greater than or equal to 0 wt % and less than or equal to 100 wt %, greater than or equal to 0 wt % and less than or equal to 80 wt %, or greater than or equal to 0 wt % and less than or equal to 60 wt %). Other ranges are also possible. In some embodiments, a prefilter comprises 0 wt % glass fibers. In some embodiments, a prefilter comprises 100 wt % glass fibers.

When present, the glass fibers may have a variety of suitable average fiber diameters. In some embodiments, a prefilter comprises glass fibers having an average fiber diameter of greater than or equal to 0.1 micron, greater than or equal to 0.15 microns, greater than or equal to 0.2 microns, greater than or equal to 0.25 microns, greater than or equal to 0.3 microns, greater than or equal to 0.4 microns, greater than or equal to 0.5 microns, greater than or equal to 0.75 microns, greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, or greater than or equal to 25 microns. In some embodiments, a prefilter comprises glass fibers having an average fiber diameter of less than or equal to 30 microns, less than or equal to 25 microns, less than or equal to 20 microns, less than or equal to 15 microns, less than or equal to 10 microns, less than or equal to 7.5 microns, less than or equal to 5 microns, less than or equal to 2 microns, less than or equal to 1 micron, less than or equal to 0.75 microns, less than or equal to 0.5 microns, less than or equal to 0.4 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 30 microns, greater than or equal to 0.2 microns and less than or equal to 20 microns, or greater than or equal to 0.3 microns and less than or equal to 10 microns). Other ranges are also possible.

When present, the glass fibers may have a variety of suitable average lengths. In some embodiments, a prefilter comprises glass fibers having an average length of greater than or equal to 1 mm, greater than or equal to 1.5 mm, greater than or equal to 2 mm, greater than or equal to 2.5 mm, greater than or equal to 3 mm, greater than or equal to 4 mm, greater than or equal to 5 mm, greater than or equal to 6 mm, greater than or equal to 8 mm, or greater than or equal to 10 mm. In some embodiments, a prefilter comprises glass fibers having an average length of less than or equal to 13 mm, less than or equal to 10 mm, less than or equal to 8 mm, less than or equal to 6 mm, less than or equal to 5 mm, less than or equal to 4 mm, less than or equal to 3 mm, less than or equal to 2.5 mm, less than or equal to 2 mm, or less than or equal to 1.5 mm. Combinations of the above-referenced ranges are also possible (e.g., greater than or equal to 1 mm and less than or equal to 13 mm, greater than or equal to 2 mm and less than or equal to 13 mm, or greater than or equal to 3 mm and less than or equal to 13 mm). Other ranges are also possible.

In some embodiments, a prefilter comprises chopped strand glass fibers. The chopped strand glass fibers may comprise chopped strand glass fibers which were produced by drawing a melt of glass from bushing tips into continuous fibers and then cutting the continuous fibers into short fibers. In some embodiments, a prefilter comprises chopped strand glass fibers for which alkali metal oxides (e.g., sodium oxides, magnesium oxides) make up a relatively low amount of the fibers. It is also possible for a prefilter to comprise chopped strand glass fibers that include relatively large amounts of calcium oxide and/or alumina (Al₂O₃). When present the chopped strand glass fibers may make up a variety of suitable amounts of the prefilter. For instance, in some embodiments, the chopped strand glass fibers make up an amount of the prefilter in one or more of the ranges described above with respect to the amount of glass fibers in the prefilter.

When present, the chopped strand glass fibers may have a variety of suitable average fiber diameters. In some embodiments, a prefilter comprises chopped strand glass fibers having an average fiber diameter of greater than or equal to 2 microns, greater than or equal to 3 microns, greater than or equal to 4 microns, greater than or equal to 5 microns, greater than or equal to 6 microns, greater than or equal to 7 microns, greater than or equal to 8 microns, greater than or equal to 9 microns, greater than or equal to 10 microns, greater than or equal to 12.5 microns, greater than or equal to 15 microns, greater than or equal to 17.5 microns, greater than or equal to 20 microns, or greater than or equal to 25 microns. In some embodiments, a prefilter comprises chopped strand glass fibers having an average fiber diameter of less than or equal to 30 microns, less than or equal to 25 microns, less than or equal to 20 microns, less than or equal to 17.5 microns, less than or equal to 15 microns, less than or equal to 12.5 microns, less than or equal to 10 microns, less than or equal to 9 microns, less than or equal to 8 microns, less than or equal to 7 microns, less than or equal to 6 microns, less than or equal to 5 microns, less than or equal to 4 microns, or less than or equal to 3 microns. Combinations of the above-referenced ranges are also possible (e.g., greater than or equal to 2 microns and less than or equal to 30 microns, greater than or equal to 2 microns and less than or equal to 20 microns, greater than or equal to 4 microns and less than or equal to 15 microns, or greater than or equal to 5 microns and less than or equal to 9 microns). Other ranges are also possible.

When present, chopped strand glass fibers may have a variety of suitable lengths. In some embodiments, a prefilter comprises chopped strand glass fibers having an average length in one or more of the ranges described elsewhere herein with respect to the average lengths of glass fibers.

In some embodiments, a prefilter comprises microglass fibers. The microglass fibers may comprise microglass fibers drawn from bushing tips and further subjected to flame blowing or rotary spinning processes. In some cases, microglass fibers may be made using a remelting process. The microglass fibers may be microglass fibers for which alkali metal oxides (e.g., sodium oxides, magnesium oxides) make up 10-20 wt % of the fibers. Such fibers may have relatively lower melting and processing temperatures. Non-limiting examples of microglass fibers are M glass fibers according to Man Made Vitreous Fibers by Nomenclature Committee of TIMA Inc. March 1993, Page 45 and C glass fibers (e.g., Lauscha C glass fibers, JM 253 C glass fibers). It should be understood that a plurality of microglass fibers may comprise one or more of the types of microglass fibers described herein. When present the microglass fibers may make up a variety of suitable amounts of the prefilter. For instance, in some embodiments, the microglass fibers make up an amount of the prefilter in one or more of the ranges described above with respect to the amount of glass fibers in the prefilter.

When present, the microglass fibers may have a variety of suitable average fiber diameters. In some embodiments, a prefilter comprises microglass fibers having an average fiber diameter of greater than or equal to 0.1 micron, greater than or equal to 0.15 microns, greater than or equal to 0.2 microns, greater than or equal to 0.25 microns, greater than or equal to 0.3 microns, greater than or equal to 0.35 microns, greater than or equal to 0.4 microns, greater than or equal to 0.5 microns, greater than or equal to 0.6 microns, greater than or equal to 0.8 microns, greater than or equal to 1 micron, greater than or equal to 1.5 microns, greater than or equal to 2 microns, greater than or equal to 2.5 microns, greater than or equal to 3 microns, greater than or equal to 4 microns, greater than or equal to 5 microns, greater than or equal to 6 microns, or greater than or equal to 8 microns. In some embodiments, a prefilter comprises microglass fibers having an average fiber diameter of less than or equal to 10 microns, less than or equal to 8 microns, less than or equal to 6 microns, less than or equal to 5 microns, less than or equal to 4 microns, less than or equal to 3 microns, less than or equal to 2.5 microns, less than or equal to 2 microns, less than or equal to 1.5 microns, less than or equal to 1 micron, less than or equal to 0.8 microns, less than or equal to 0.6 microns, less than or equal to 0.5 microns, less than or equal to 0.4 microns, less than or equal to 0.35 microns, less than or equal to 0.3 microns, less than or equal to 0.25 microns, less than or equal to 0.2 microns, or less than or equal to 0.15 microns. Combinations of the above-referenced ranges are also possible (e.g., greater than or equal to 0.1 micron and less than or equal to 10 microns, greater than or equal to 0.2 microns and less than or equal to 6 microns, or greater than or equal to 0.3 microns and less than or equal to 2 microns). Other ranges are also possible.

When present, microglass fibers may have a variety of suitable lengths. In some embodiments, a prefilter comprises microglass fibers having an average length in one or more of the ranges described elsewhere herein with respect to the average lengths of glass fibers.

In some embodiments, a prefilter comprises natural fibers, such as cellulose fibers. When present, the cellulose fibers may comprise any suitable types of cellulose. In some embodiments, the cellulose fibers may comprise natural cellulose fibers, such as cellulose wood (e.g., cedar), softwood fibers, and/or hardwood fibers. Exemplary softwood fibers include fibers obtained from mercerized southern pine (“mercerized southern pine fibers or HPZ fibers”), northern bleached softwood kraft (e.g., fibers obtained from Robur Flash (“Robur Flash fibers”)), southern bleached softwood kraft (e.g., fibers obtained from Brunswick pine (“Brunswick pine fibers”)), and/or chemically treated mechanical pulps (“CTMP fibers”). For example, HPZ fibers can be obtained from Buckeye Technologies, Inc., Memphis, Tenn.; Robur Flash fibers can be obtained from Rottneros AB, Stockholm, Sweden; and Brunswick pine fibers can be obtained from Georgia-Pacific, Atlanta, Ga.

Exemplary hardwood fibers include fibers obtained from Eucalyptus (“Eucalyptus fibers”). Eucalyptus fibers are commercially available from, e.g., (1) Suzano Group, Suzano, Brazil (“Suzano fibers”), (2) Group Portucel Soporcel, Cacia, Portugal (“Cacia fibers”), (3) Tembec, Inc., Temiscaming, QC, Canada (“Tarascon fibers”), (4) Kartonimex Intercell, Duesseldorf, Germany, (“Acacia fibers”), (5) Mead-Westvaco, Stamford, Conn. (“Westvaco fibers”), and (6) Georgia-Pacific, Atlanta, Ga. (“Leaf River fibers”).

The cellulose fibers, when present, may comprise fibrillated cellulose fibers, and/or may comprise unfibrillated cellulose fibers.

When present, the cellulose fibers may make up a variety of suitable amounts of a prefilter. In some embodiments, cellulose fibers make up greater than or equal to 0 wt %, greater than or equal to 1 wt %, greater than or equal to 2 wt %, greater than or equal to 5 wt %, greater than or equal to 7.5 wt %, greater than or equal to 10 wt %, greater than or equal to 15 wt %, greater than or equal to 20 wt %, greater than or equal to 30 wt %, greater than or equal to 40 wt %, greater than or equal to 50 wt %, greater than or equal to 60 wt %, greater than or equal to 70 wt %, greater than or equal to 80 wt %, or greater than or equal to 90 wt % of the prefilter. In some embodiments, cellulose fibers make up less than or equal to 100 wt %, less than or equal to 90 wt %, less than or equal to 80 wt %, less than or equal to 70 wt %, less than or equal to 60 wt %, less than or equal to 50 wt %, less than or equal to 40 wt %, less than or equal to 30 wt %, less than or equal to 20 wt %, less than or equal to 15 wt %, less than or equal to 10 wt %, less than or equal to 7.5 wt %, less than or equal to 5 wt %, less than or equal to 2 wt %, or less than or equal to 1 wt % of the prefilter. Combinations of the above-referenced ranges are also possible (e.g., greater than or equal to 0 wt % and less than or equal to 100 wt %, greater than or equal to 0 wt % and less than or equal to 80 wt %, or greater than or equal to 0 wt % and less than or equal to 60 wt %). Other ranges are also possible. In some embodiments, a prefilter comprises 0 wt % cellulose fibers. In some embodiments, a prefilter comprises 100 wt % cellulose fibers.

When present, cellulose fibers may have a variety of suitable average fiber diameters. In some embodiments, a prefilter comprises cellulose fibers having an average fiber diameter of greater than or equal to 1 micron, greater than or equal to 2 microns, greater than or equal to 5 microns, greater than or equal to 7.5 microns, greater than or equal to 10 microns, greater than or equal to 15 microns, greater than or equal to 20 microns, greater than or equal to 25 microns, greater than or equal to 30 microns, greater than or equal to 35 microns, greater than or equal to 40 microns, greater than or equal to 45 microns, greater than or equal to 50 microns, greater than or equal to 60 microns, greater than or equal to 70 microns, greater than or equal to 80 microns, or greater than or equal to 90 microns. In some embodiments, a prefilter comprises cellulose fibers having an average fiber diameter of less than or equal to 100 microns, less than or equal to 90 microns, less than or equal to 80 microns, less than or equal to 70 microns, less than or equal to 60 microns, less than or equal to 50 microns, less than or equal to 45 microns, less than or equal to 40 microns, less than or equal to 35 microns, less than or equal to 30 microns, less than or equal to 25 microns, less than or equal to 20 microns, less than or equal to 15 microns, less than or equal to 10 microns, less than or equal to 7.5 microns, less than or equal to 5 microns, or less than or equal to 2 microns. Combinations of the above-referenced ranges are also possible (e.g., greater than or equal to 1 micron and less than or equal to 100 microns, greater than or equal to 5 microns and less than or equal to 80 microns, or greater than or equal to 10 microns and less than or equal to 45 microns). Other ranges are also possible.

When present, cellulose fibers may have a variety of suitable average lengths. In some embodiments, a prefilter comprises cellulose fibers having an average length of greater than or equal to 0.1 mm, greater than or equal to 0.2 mm, greater than or equal to 0.5 mm, greater than or equal to 0.75 mm, greater than or equal to 1 mm, greater than or equal to 2 mm, greater than or equal to 5 mm, greater than or equal to 7.5 mm, greater than or equal to 10 mm, or greater than or equal to 15 mm. In some embodiments, a prefilter comprises cellulose fibers having an average length of less than or equal to 20 mm, less than or equal to 15 mm, less than or equal to 10 mm, less than or equal to 7.5 mm, less than or equal to 5 mm, less than or equal to 2 mm, less than or equal to 1 mm, less than or equal to 0.75 mm, less than or equal to 0.5 mm, or less than or equal to 0.2 mm. Combinations of the above-referenced ranges are also possible (e.g., greater than or equal to 0.1 mm and less than or equal to 20 mm, greater than or equal to 0.5 mm and less than or equal to 10 mm, or greater than or equal to 1 mm and less than or equal to 5 mm). Other ranges are also possible.

In some embodiments, a prefilter comprises one or more additives, one example of which is a charge-stabilizing additive. One example of a suitable class of charge-stabilizing additives is hindered amine light stabilizers. Without wishing to be bound by any particular theory, it is believed that hindered amine light stabilizers are capable accepting and stabilizing charged species (e.g., a positively charged species, such as a proton from water; a negatively charged species) thereon. Further non-limiting examples of suitable charge-stabilizing additives include fused aromatic thioureas, organic triazines, UV stabilizers, phosphites, additives comprising two or more amide groups (e.g., bisamides, trisamides), stearates (e.g., magnesium stearate, calcium stearate), and stearamides (e.g., ethylene bis-stearamide). Charge-stabilizing additives may be incorporated into fibers and/or may be incorporated into the prefilter in another manner (e.g., as particles, as a coating on the fibers). One example of a manner in which charge-stabilizing additives may be incorporated into fibers is by forming a continuous fiber from a composition comprising the charge-stabilizing additive.

Another example of a suitable type of additive is an additive that enhances the heat stability of the prefilter. For instance, such additives may reduce the degradation exhibited by one or more polymers present in the prefilter upon exposure to heat. The degradation reduced may comprise a change in one or more physical or chemical properties of the polymer as observed by gel permeation chromatography (e.g., in the case of degradation that comprises a change in molecular weight), changes in melt viscosity, and/or changes in color. Non-limiting examples of such additives include phosphites, phenolics, hydroxyl amines and hindered amine light stabilizers.

In some embodiments, a prefilter comprises fibers that comprise oleophobic properties, comprises an oleophobic component (e.g., an oleophobic additive), and/or is surface-modified. In such embodiments, the prefilter may comprise oleophobic properties, comprise an oleophobic component and/or be surface modified in one or more of the ways described with respect to nanofiber layers that comprise oleophobic properties, comprise an oleophobic component, and/or are surface-modified. In some embodiments, the prefilter comprises a coating (e.g., an oleophobic coating, an oleophobic component that is an oleophobic coating) and/or comprises a resin (e.g., an oleophobic resin, an oleophobic component that is an oleophobic resin). In such embodiments, the prefilter may comprise a coating and/or a resin as described with respect to nanofiber layers that comprise a coating and/or a resin.

It is also possible for prefilters to comprise fibers that comprise hydrophobic properties, to comprise a hydrophobic component (e.g., a hydrophobic additive), and/or to be surface-modified to be hydrophobic. In such embodiments, the prefilter may comprise hydrophobic properties, comprise a hydrophobic component and/or be surface modified in one or more of the ways described with respect to nanofiber layers that comprise hydrophobic properties, comprise a hydrophobic component, and/or are surface-modified. In some embodiments, the prefilter comprises a hydrophobic coating and/or comprises a hydrophobic resin. In such embodiments, the prefilter may comprise a hydrophobic coating and/or a hydrophobic resin as described with respect to nanofiber layers that comprise a coating and/or a resin. Similarly, some prefilters may have a contact angle in one or more of the ranges described for the contact angles of hydrophobic nanofiber layers.

In some embodiments, a prefilter comprises fibers that comprise hydrophilic properties, comprise a hydrophobic component (e.g., a hydrophilic additive), and/or to are surface-modified to be hydrophilic. In such embodiments, the prefilter may comprise hydrophilic properties, comprise a hydrophilic component and/or be surface modified in one or more of the ways described with respect to nanofiber layers that comprise hydrophilic properties, comprise a hydrophilic component, and/or are surface-modified. Similarly, some prefilters may have a contact angle in one or more of the ranges described for the contact angles of hydrophilic nanofiber layers. It is also possible for a prefilter to be hydrophilic and comprise glass fibers and/or cellulose fibers.

In some embodiments, a prefilter is charged. In such embodiments, the prefilter may be charged in one or more of the ways described above with respect to charged nanofiber layers. For instance, in some embodiments, a prefilter is hydrocharged by performing a procedure described for hydro charging elsewhere herein with respect to charged nanofiber layers. In some embodiments, a filter media comprises a prefilter that is a meltblown fiber web and is hydro charged. Such prefilters may comprise synthetic fibers, such as synthetic fibers that have average fiber diameters in one or more of the ranges described elsewhere herein for such fibers (e.g., greater than or equal to 0.4 microns and less than or equal to 50 microns, greater than or equal to 0.5 microns and less than or equal to 30 microns, or greater than or equal to 1 micron and less than or equal to 20 microns).

As another example, in some embodiments, a prefilter is triboelectrically charged. In some embodiments, a filter media comprises a prefilter that is a carded non-woven fiber web (e.g., comprising acrylic fibers (e.g., dryspun acrylic and/or modacrylic fibers) and poly(propylene) fibers) that is triboelectrically charged. The triboelectric charging may occur during the carding process when two or more types of fibers having different positions along the triboelectric series (such as the acrylic and poly(propylene) fibers mentioned in the previous sentence) are present. For instance, in some embodiments, a filter media comprises a prefilter that is a triboelectrically-charged, carded, non-woven fiber web comprising a ratio of acrylic fibers (e.g., dryspun acrylic and/or modacrylic fibers) to poly(propylene) fibers of greater than or equal to 5:95 and less than or equal to 95:5 or greater than or equal to 30:70 and less than or equal to 70:30. The fibers of each type may have a diameter in one or more of the ranges described elsewhere herein with respect to synthetic fibers (e.g., greater than or equal to 15 microns and less than or equal to 25 microns).

It is also possible for a filter media to comprise a prefilter that is uncharged.

When present, a prefilter may have a variety of suitable basis weights. In some embodiments, a prefilter has a basis weight of greater than or equal to 1 g/m², greater than or equal to 1.5 g/m², greater than or equal to 2 g/m², greater than or equal to 3 g/m², greater than or equal to 4 g/m², greater than or equal to 5 g/m², greater than or equal to 7.5 g/m², greater than or equal to 10 g/m², greater than or equal to 20 g/m², greater than or equal to 50 g/m², greater than or equal to 75 g/m², greater than or equal to 100 g/m², greater than or equal to 150 g/m², greater than or equal to 200 g/m², greater than or equal to 250 g/m², greater than or equal to 300 g/m², greater than or equal to 350 g/m², greater than or equal to 400 g/m², greater than or equal to 450 g/m², greater than or equal to 500 g/m², or greater than or equal to 550 g/m². In some embodiments, a prefilter has a basis weight of less than or equal to 600 g/m², less than or equal to 550 g/m², less than or equal to 500 g/m², less than or equal to 450 g/m², less than or equal to 400 g/m², less than or equal to 350 g/m², less than or equal to 300 g/m², less than or equal to 250 g/m², less than or equal to 200 g/m², less than or equal to 150 g/m², less than or equal to 100 g/m², less than or equal to 75 g/m², less than or equal to 50 g/m², less than or equal to 20 g/m², less than or equal to 10 g/m², less than or equal to 7.5 g/m², less than or equal to 5 g/m², less than or equal to 4 g/m², less than or equal to 3 g/m², less than or equal to 2 g/m², or less than or equal to 1.5 g/m². Combinations of the above-referenced ranges are also possible (e.g., greater than or equal to 1 g/m² and less than or equal to 600 g/m², greater than or equal to 2 g/m² and less than or equal to 300 g/m², or greater than or equal to 5 g/m² and less than or equal to 100 g/m²). Other ranges are also possible. The basis weight of a prefilter may be determined in accordance with ISO 536:2012.

When present, a prefilter may have a variety of suitable thicknesses. In some embodiments, a prefilter has a thickness of greater than or equal to 0.01 mm, greater than or equal to 0.02 mm, greater than or equal to 0.03 mm, greater than or equal to 0.05 mm, greater than or equal to 0.075 mm, greater than or equal to 0.1 mm, greater than or equal to 0.2 mm, greater than or equal to 0.5 mm, greater than or equal to 0.75 mm, greater than or equal to 1 mm, greater than or equal to 1.5 mm, greater than or equal to 2 mm, greater than or equal to 3 mm, greater than or equal to 4 mm, or greater than or equal to 6 mm. In some embodiments, a prefilter has a thickness of less than or equal to 8 mm, less than or equal to 6 mm, less than or equal to 4 mm, less than or equal to 3 mm, less than or equal to 2 mm, less than or equal to 1.5 mm, less than or equal to 1 mm, less than or equal to 0.75 mm, less than or equal to 0.5 mm, less than or equal to 0.2 mm, less than or equal to 0.1 mm, less than or equal to 0.075 mm, less than or equal to 0.05 mm, less than or equal to 0.03 mm, or less than or equal to 0.02 mm. Combinations of the above-referenced ranges are also possible (e.g., greater than or equal to 0.01 mm and less than or equal to 8 mm, greater than or equal to 0.05 mm and less than or equal to 4 mm, or greater than or equal to 0.1 mm and less than or equal to 2 mm). Other ranges are also possible. The thickness of a prefilter may be determined in accordance with ASTM D1777 (2015) under an applied pressure of 0.8 kPa.

When present, a prefilter may have a variety of suitable solidities. In some embodiments, a prefilter has a solidity of greater than or equal to 1%, greater than or equal to 1.5%, greater than or equal to 2%, greater than or equal to 2.5%, greater than or equal to 3%, greater than or equal to 4%, greater than or equal to 5%, greater than or equal to 7.5%, greater than or equal to 10%, greater than or equal to 12.5%, greater than or equal to 15%, greater than or equal to 17.5%, greater than or equal to 20%, or greater than or equal to 22.5%. In some embodiments, a prefilter has a solidity of less than or equal to 25%, less than or equal to 22.5%, less than or equal to 20%, less than or equal to 17.5%, less than or equal to 15%, less than or equal to 12.5%, less than or equal to 10%, less than or equal to 7.5%, less than or equal to 5%, less than or equal to 4%, less than or equal to 3%, less than or equal to 2.5%, less than or equal to 2%, or less than or equal to 1.5%. Combinations of the above-referenced ranges are also possible (e.g., greater than or equal to 1% and less than or equal to 25%, greater than or equal to 2% and less than or equal to 15%, or greater than or equal to 3% and less than or equal to 10%). Other ranges are also possible. The solidity of a prefilter may be determined by the same techniques that may be employed to determine the solidity of a nanofiber layer described elsewhere herein.

When present, a prefilter may have a variety of suitable air permeabilities. In some embodiments, a prefilter has an air permeability of greater than or equal to 1 CFM, greater than or equal to 2 CFM, greater than or equal to 10 CFM, greater than or equal to 20 CFM, greater than or equal to 50 CFM, greater than or equal to 75 CFM, greater than or equal to 100 CFM, greater than or equal to 200 CFM, greater than or equal to 500 CFM, greater than or equal to 800 CFM, greater than or equal to 1000 CFM, or greater than or equal to 1250 CFM. In some embodiments, a prefilter has an air permeability of less than or equal to 1500 CFM, less than or equal to 1250 CFM, less than or equal to 1000 CFM, less than or equal to 800 CFM, less than or equal to 500 CFM, less than or equal to 200 CFM, less than or equal to 100 CFM, less than or equal to 75 CFM, less than or equal to 50 CFM, less than or equal to 20 CFM, less than or equal to 10 CFM, or less than or equal to 2 CFM. Combinations of the above-referenced ranges are also possible (e.g., greater than or equal to 1 CFM and less than or equal to 1500 CFM, greater than or equal to 10 CFM and less than or equal to 800 CFM, greater than or equal to 20 CFM and less than or equal to 500 CFM, or greater than or equal to 100 CFM and less than or equal to 500 CFM). The air permeability may be determined in accordance with ASTM D737-04 (2016) at a pressure of 125 Pa.

When present, a prefilter may have a relatively low initial air resistance. The initial air resistance may be less than or equal to 1000 Pa, less than or equal to 800 Pa, less than or equal to 600 Pa, less than or equal to 500 Pa, less than or equal to 400 Pa, less than or equal to 300 Pa, less than or equal to 200 Pa, less than or equal to 100 Pa, less than or equal to 75 Pa, less than or equal to 50 Pa, less than or equal to 20 Pa, less than or equal to 10 Pa, less than or equal to 7.5 Pa, less than or equal to 5 Pa, or less than or equal to 2 Pa. The initial air resistance may be greater than or equal to 1 Pa, greater than or equal to 2 Pa, greater than or equal to 5 Pa, greater than or equal to 7.5 Pa, greater than or equal to 10 Pa, greater than or equal to 20 Pa, greater than or equal to 50 Pa, greater than or equal to 75 Pa, greater than or equal to 100 Pa, greater than or equal to 200 Pa, greater than or equal to 300 Pa, greater than or equal to 400 Pa, greater than or equal to 500 Pa, greater than or equal to 600 Pa, or greater than or equal to 800 Pa. Combinations of the above-referenced ranges are also possible (e.g., greater than or equal to 1 Pa and less than or equal to 1000 Pa, greater than or equal to 1 Pa and less than or equal to 500 Pa, or greater than or equal to 1 Pa and less than or equal to 200 Pa). Other ranges are also possible. The initial air resistance of a prefilter may be determined concurrently with its initial DEHS (diethylhexylsebacate) penetration at 0.33 microns, which is described in further detail elsewhere herein.

In some embodiments, a prefilter may have a relatively low initial DEHS penetration at 0.33 microns. The initial DEHS penetration at 0.33 microns may be less than or equal to 90%, less than or equal to 80%, less than or equal to 70%, less than or equal to 60%, less than or equal to 50%, less than or equal to 40%, less than or equal to 30%, less than or equal to 25%, less than or equal to 20%, less than or equal to 15%, less than or equal to 10%, less than or equal to 7.5%, less than or equal to 5%, less than or equal to 2%, less than or equal to 1%, less than or equal to 0.75%, less than or equal to 0.5%, less than or equal to 0.2%, less than or equal to 0.1%, less than or equal to 0.0075%, less than or equal to 0.005%, or less than or equal to 0.002%. The initial DEHS penetration at 0.33 microns may be greater than or equal to 0.001%, greater than or equal to 0.002%, greater than or equal to 0.005%, greater than or equal to 0.0075%, greater than or equal to 0.01%, greater than or equal to 0.02%, greater than or equal to 0.05%, greater than or equal to 0.075%, greater than or equal to 0.1%, greater than or equal to 0.2%, greater than or equal to 0.5%, greater than or equal to 0.75%, greater than or equal to 1%, greater than or equal to 2%, greater than or equal to 5%, greater than or equal to 7.5%, greater than or equal to 10%, greater than or equal to 15%, greater than or equal to 20%, greater than or equal to 25%, greater than or equal to 30%, greater than or equal to 40%, greater than or equal to 50%, greater than or equal to 60%, greater than or equal to 70%, or greater than or equal to 80%. Combinations of the above-referenced ranges are also possible (e.g., greater than or equal to 0.001% and less than or equal to 90%, greater than or equal to 0.001% and less than or equal to 50%, or greater than or equal to 0.001% and less than or equal to 30%). Other ranges are also possible.

Penetration, often expressed as a percentage, is defined as follows: Pen (%)=(C/C₀)·100% where C is the particle concentration after passage through the prefilter and Co is the particle concentration before passage through the prefilter. The initial penetration for 0.33 micron DEHS particles may be measured by blowing DEHS particles through a prefilter and measuring the percentage of particles that penetrate therethrough. This may be accomplished by use of a TSI 8130 automated filter testing unit from TSI, Inc. equipped with a DEHS generator for DEHS aerosol testing for 0.33 micron DEHS particles. The TSI 8130 automated filter testing unit may be employed to perform an automated procedure entitled “Filter Test” encoded by the software therein for 0.33 micron particles at a face velocity of 5.33 cm/s. Briefly, this test comprises blowing DEHS particles with an average particle diameter of 0.33 microns at a 100 cm² face area of the upstream face of the prefilter. The upstream and downstream particle concentrations may be measured by use of condensation particle counters. During the penetration measurement, the 100 cm² face area of the upstream face of the prefilter may be subject to a continuous flow of DEHS particles at a media face velocity of 5.33 cm/s until the penetration reading is determined to be stable by the TSI 8130 automated filter testing unit.

In some embodiments, a filter media may, as a whole, have one or more relatively advantageous properties. Selected properties of some filter media are described in further detail below.

The filter media described herein may have a variety of suitable basis weights. In some embodiments, a filter media has a basis weight of greater than or equal to 80 g/m², greater than or equal to 90 g/m², greater than or equal to 100 g/m², greater than or equal to 125 g/m², greater than or equal to 150 g/m², greater than or equal to 190 g/m², greater than or equal to 200 g/m², greater than or equal to 225 g/m², greater than or equal to 250 g/m², greater than or equal to 275 g/m², greater than or equal to 300 g/m², greater than or equal to 350 g/m², greater than or equal to 400 g/m², greater than or equal to 450 g/m², greater than or equal to 500 g/m², greater than or equal to 550 g/m², greater than or equal to 600 g/m², greater than or equal to 650 g/m², greater than or equal to 700 g/m², greater than or equal to 750 g/m², greater than or equal to 800 g/m², greater than or equal to 900 g/m², greater than or equal to 1000 g/m², greater than or equal to 1250 g/m², greater than or equal to 1500 g/m², or greater than or equal to 1750 g/m². In some embodiments, a filter media has a basis weight of less than or equal to 2000 g/m², less than or equal to 1750 g/m², less than or equal to 1500 g/m², less than or equal to 1250 g/m², less than or equal to 1000 g/m², less than or equal to 900 g/m², less than or equal to 800 g/m², less than or equal to 750 g/m², less than or equal to 700 g/m², less than or equal to 650 g/m², less than or equal to 600 g/m², less than or equal to 550 g/m², less than or equal to 500 g/m², less than or equal to 450 g/m², less than or equal to 400 g/m², less than or equal to 350 g/m², less than or equal to 300 g/m², less than or equal to 275 g/m², less than or equal to 250 g/m², less than or equal to 225 g/m², less than or equal to 200 g/m², less than or equal to 190 g/m², less than or equal to 175 g/m², less than or equal to 150 g/m², less than or equal to 125 g/m², less than or equal to 100 g/m², or less than or equal to 90 g/m². Combinations of the above-referenced ranges are also possible (e.g., greater than or equal to 80 g/m² and less than or equal to 2000 g/m², greater than or equal to 190 g/m² and less than or equal to 1250 g/m², or greater than or equal to 190 g/m² and less than or equal to 750 g/m²). Other ranges are also possible. The basis weight of a filter media may be determined in accordance with ISO 536:2012.

The filter media described herein may have a variety of suitable thicknesses. In some embodiments, a filter media has a thickness of greater than or equal to 0.4 mm, greater than or equal to 0.5 mm, greater than or equal to 0.6 mm, greater than or equal to 0.7 mm, greater than or equal to 0.8 mm, greater than or equal to 0.9 mm, greater than or equal to 1 mm, greater than or equal to 1.25 mm, greater than or equal to 1.5 mm, greater than or equal to 1.75 mm, greater than or equal to 2 mm, greater than or equal to 2.6 mm, greater than or equal to 3 mm, greater than or equal to 3.4 mm, greater than or equal to 4 mm, greater than or equal to 4.5 mm, greater than or equal to 5 mm, greater than or equal to 6 mm, greater than or equal to 7 mm, greater than or equal to 8 mm, greater than or equal to 9 mm, greater than or equal to 10 mm, greater than or equal to 12.5 mm, greater than or equal to 15 mm, greater than or equal to 17.5 mm, greater than or equal to 20 mm, or greater than or equal to 25 mm. In some embodiments, a filter media has a thickness of less than or equal to 30 mm, less than or equal to 25 mm, less than or equal to 20 mm, less than or equal to 17.5 mm, less than or equal to 15 mm, less than or equal to 12.5 mm, less than or equal to 10 mm, less than or equal to 9 mm, less than or equal to 8 mm, less than or equal to 7 mm, less than or equal to 6 mm, less than or equal to 5 mm, less than or equal to 4.5 mm, less than or equal to 4 mm, less than or equal to 3.4 mm, less than or equal to 3 mm, less than or equal to 2.6 mm, less than or equal to 2 mm, less than or equal to 1.75 mm, less than or equal to 1.5 mm, less than or equal to 1.25 mm, less than or equal to 1 mm, less than or equal to 0.9 mm, less than or equal to 0.8 mm, less than or equal to 0.7 mm, less than or equal to 0.6 mm, or less than or equal to 0.5 mm. Combinations of the above-referenced ranges are also possible (e.g., greater than or equal to 0.4 mm and less than or equal to 30 mm, greater than or equal to 0.4 mm and less than or equal to 5 mm, greater than or equal to 0.8 mm and less than or equal to 3.4 mm, or greater than or equal to 0.9 mm and less than or equal to 2.6 mm). Other ranges are also possible. The thickness of a filter media may be determined in accordance with ISO 534 (2011) by applying a 2 N/cm² pressure to a sample of the layer having an area of 2 cm².

The filter media described herein may have a variety of suitable air permeabilities. In some embodiments, a filter media has an air permeability of greater than or equal to 10 CFM, greater than or equal to 15 CFM, greater than or equal to 20 CFM, greater than or equal to 25 CFM, greater than or equal to 30 CFM, greater than or equal to 35 CFM, greater than or equal to 40 CFM, greater than or equal to 45 CFM, greater than or equal to 50 CFM, greater than or equal to 55 CFM, greater than or equal to 60 CFM, greater than or equal to 65 CFM, greater than or equal to 70 CFM, or greater than or equal to 75 CFM. In some embodiments, a filter media has an air permeability of less than or equal to 81 CFM, less than or equal to 75 CFM, less than or equal to 70 CFM, less than or equal to 65 CFM, less than or equal to 60 CFM, less than or equal to 55 CFM, less than or equal to 50 CFM, less than or equal to 45 CFM, less than or equal to 40 CFM, less than or equal to 35 CFM, less than or equal to 30 CFM, less than or equal to 25 CFM, less than or equal to 20 CFM, or less than or equal to 15 CFM. Combinations of the above-referenced ranges are also possible (e.g., greater than or equal to 20 CFM and less than or equal to 81 CFM, greater than or equal to 10 CFM and less than or equal to 45 CFM, or greater than or equal to 45 CFM and less than or equal to 81 CFM). Other ranges are also possible. The air permeability of a filter media may be determined in accordance with ASTM D737-04 (2016) at a pressure of 125 Pa.

The filter media described herein may have a variety of suitable initial air resistances. In some embodiments, a filter media has an initial air resistance of greater than or equal to 64 Pa, greater than or equal to 66 Pa, greater than or equal to 68 Pa, greater than or equal to 70 Pa, greater than or equal to 72 Pa, greater than or equal to 74 Pa, greater than or equal to 76 Pa, or greater than or equal to 78 Pa. In some embodiments, a filter media has an initial air resistance of less than or equal to 80 Pa, less than or equal to 78 Pa, less than or equal to 76 Pa, less than or equal to 74 Pa, less than or equal to 72 Pa, less than or equal to 70 Pa, less than or equal to 68 Pa, or less than or equal to 66 Pa. Combinations of the above-referenced ranges are also possible (e.g., greater than or equal to 64 Pa and less than or equal to 80 Pa). Other ranges are also possible. The initial air resistance of the filter media may be determined concurrently with the initial DEHS penetration at 0.33 microns as described elsewhere herein.

In some embodiments, the filter media advantageously has an initial air resistance after being exposed to isopropyl alcohol vapor that is relatively low and/or relatively similar to its initial air resistance prior to be exposed to isopropyl alcohol vapor. This may be indicative of the presence of components in the filter media that do not appreciably flow and/or react upon exposure to isopropyl alcohol vapor and/or that comprise in relatively low amounts (and/or lack) such components.

In some embodiments, the filter media has an initial air resistance after being exposed to isopropyl alcohol of less than or equal to 80 Pa, less than or equal to 78 Pa, less than or equal to 76 Pa, less than or equal to 74 Pa, less than or equal to 72 Pa, less than or equal to 70 Pa, less than or equal to 68 Pa, less than or equal to 66 Pa, less than or equal to 64 Pa, less than or equal to 62 Pa, or less than or equal to 60 Pa. In some embodiments, the filter media has an initial air resistance after being exposed to isopropyl alcohol of greater than or equal to 58 Pa, greater than or equal to 60 Pa, greater than or equal to 62 Pa, greater than or equal to 64 Pa, greater than or equal to 66 Pa, greater than or equal to 68 Pa, greater than or equal to 70 Pa, greater than or equal to 72 Pa, greater than or equal to 74 Pa, greater than or equal to 76 Pa, or greater than or equal to 78 Pa. Combinations of the above-referenced ranges are also possible (e.g., greater than or equal to 58 Pa and less than or equal to 80 Pa). Other ranges are also possible.

The initial air resistance after exposure to isopropyl alcohol vapor may be determined by exposing the filter media to isopropyl alcohol vapor and then measuring the air resistance in the same manner as the initial air resistance would otherwise be measured. The filter media may be exposed to isopropyl alcohol vapor by in accordance with the ISO 16890-4 (2016) standard on a 6 in by 6 in sample. A filter media to be tested may be cut into a 6 in by 6 in square and placed on a shelf of a metal rack. Then, the metal rack and the media may be placed over a container comprising at least 250 mL of 99.9 wt % isopropyl alcohol. After this step, the metal rack, media, and container may be placed inside a 24 in by 18 in by 11 in chamber. A second container comprising 250 mL of 99.9 wt % isopropyl alcohol may then be placed in the container over the top shelf of the metal rack, and the lid of the chamber may be closed and tightly sealed. This setup may be maintained at 70° F. and 50% relative humidity for at least 14 hours, after which the filter media may be removed and allowed to dry for one hour at room temperature. Then, the filter media properties characterized as being those after undergoing an isopropyl alcohol vapor discharge process, including the filter media's initial air resistance, may be measured.

In some embodiments, a filter media has an initial DEHS penetration at 0.33 microns that is relatively low. The initial DEHS penetration at 0.33 microns may be less than or equal to 10%, less than or equal to 8%, less than or equal to 6%, less than or equal to 5%, less than or equal to 4%, less than or equal to 3%, less than or equal to 2%, less than or equal to 1%, less than or equal to 0.75%, less than or equal to 0.5%, less than or equal to 0.2%, less than or equal to 0.1%, less than or equal to 0.075%, less than or equal to 0.05%, less than or equal to 0.02%, less than or equal to 0.01%, less than or equal to 0.005%, less than or equal to 0.0005%, or less than or equal to 0.00005%. The initial DEHS penetration at 0.33 microns may be greater than or equal to 0.000005%, greater than or equal to 0.00005%, greater than or equal to 0.0005%, greater than or equal to 0.005%, greater than or equal to 0.01%, greater than or equal to 0.02%, greater than or equal to 0.05%, greater than or equal to 0.075%, greater than or equal to 0.1%, greater than or equal to 0.2%, greater than or equal to 0.5%, greater than or equal to 0.75%, greater than or equal to 1%, greater than or equal to 2%, greater than or equal to 3%, greater than or equal to 4%, greater than or equal to 6%, or greater than or equal to 8%. Combinations of the above-referenced ranges are also possible (e.g., greater than or equal to 0.000005% and less than or equal to 10%, or greater than or equal to 3% and less than or equal to 5%). Other ranges are also possible. The initial DEHS penetration at 0.33 microns of a filter media may be determined by employing the method described with respect to the determination of the initial DEHS at 0.33 microns for a prefilter.

In some embodiments, a filter media has an initial DEHS penetration at 0.33 microns that is relatively low even after exposure to isopropyl alcohol vapor. The initial DEHS penetration at 0.33 microns after exposure to isopropyl alcohol vapor may be less than or equal to 40%, less than or equal to 37.5%, less than or equal to 35%, less than or equal to 32.5%, less than or equal to 30%, less than or equal to 27.5%, less than or equal to 25%, less than or equal to 22.5%, less than or equal to 20%, or less than or equal to 17.5%. The initial DEHS penetration at 0.33 microns after exposure to isopropyl alcohol vapor may be greater than or equal to 15%, greater than or equal to 17.5%, greater than or equal to 20%, greater than or equal to 22.5%, greater than or equal to 25%, greater than or equal to 27.5%, greater than or equal to 30%, greater than or equal to 32.5%, greater than or equal to 35%, or greater than or equal to 37.5%. Combinations of the above-referenced ranges are also possible (e.g., less than or equal to 40% and greater than or equal to 15%). Other ranges are also possible. The initial DEHS penetration at 0.33 microns may be determined by exposing a filter media to isopropyl alcohol vapor as described elsewhere herein with respect to the measurement of initial air resistance after exposure to isopropyl alcohol vapor and then determining the initial DEHS penetration at 0.33 microns as described with respect to the determination of the initial DEHS at 0.33 microns for a prefilter.

The filter media described herein may have initial values of gamma at 0.33 microns of greater than or equal to 17, greater than or equal to 18, greater than or equal to 19, greater than or equal to 20, greater than or equal to 21, greater than or equal to 25, greater than or equal to 30, greater than or equal to 40, greater than or equal to 50, greater than or equal to 75, greater than or equal to 100, greater than or equal to 125, greater than or equal to 150, or greater than or equal to 175. In some embodiments, a filter media has an initial value of gamma of less than or equal to 200, less than or equal to 175, less than or equal to 150, less than or equal to 125, less than or equal to 100, less than or equal to 75, less than or equal to 50, less than or equal to 40, less than or equal to 30, less than or equal to 25, less than or equal to 21, less than or equal to 20, less than or equal to 19, or less than or equal to 18. Combinations of the above-referenced ranges are also possible (e.g., greater than or equal to 17 and less than or equal to 200, or greater than or equal to 17 and less than or equal to 100). Other ranges are also possible. Initial gamma is defined by the following formula: Gamma=(−log 10(Initial penetration %/100)/(air resistance, Pa/9.81)·100. Initial gamma at 0.33 microns may be measured by determining the initial DEHS penetration at 0.33 microns and the initial air resistance at 0.33 microns as described elsewhere herein and then applying the formula above.

In some embodiments, a filter media has an appreciable initial gamma at 0.33 microns even after exposure to isopropyl alcohol vapor. In some embodiments, a filter media has an initial gamma at 0.33 microns after exposure to isopropyl alcohol vapor of greater than or equal to 4, greater than or equal to 5, greater than or equal to 7.5, greater than or equal to 10, greater than or equal to 12.5, greater than or equal to 15, or greater than or equal to 17.5. In some embodiments, a filter media has an initial gamma at 0.33 microns after exposure to isopropyl alcohol vapor of less than or equal to 20, less than or equal to 17.5, less than or equal to 15, less than or equal to 12.5, less than or equal to 10, less than or equal to 7.5, or less than or equal to 5. Combinations of the above-referenced ranges are also possible (e.g., greater than or equal to 4 and less than or equal to 20). Other ranges are also possible. The initial gamma at 0.33 microns may be determined by exposing a filter media to isopropyl alcohol vapor as described elsewhere herein with respect to the measurement of initial air resistance after exposure to isopropyl alcohol vapor and then determining the initial gamma at 0.33 microns as described in the preceding paragraph.

In some embodiments, a filter media described herein is a filter media suitable for high efficiency particulate air (HEPA) or ultra low particulate air (ULPA). These filters are required to remove particulates at an efficiency level specified by EN1822:2009. In some embodiments, the filter media removes particulates at an efficiency of greater than 99.95% (H 13), greater than 99.995% (H 14), greater than 99.9995% (U 15), greater than 99.99995% (U 16), or greater than 99.999995% (U 17).

In some embodiments, a filter media described herein may be a component of a filter element. That is, the filter media may be incorporated into an article suitable for use by an end user.

Non-limiting examples of suitable filter elements include cabin air filters, flat panel filters, V-bank filters (comprising, e.g., between 1 and 24 Vs), cartridge filters, cylindrical filters, conical filters, and curvilinear filters. Filter elements may have any suitable height (e.g., between 2 in and 124 in for flat panel filters, between 4 in and 124 in for V-bank filters, between 1 in and 124 in for cartridge and cylindrical filter media). Filter elements may also have any suitable width (between 2 in and 124 in for flat panel filters, between 4 in and 124 in for V-bank filters). Some filter media (e.g., cartridge filter media, cylindrical filter media) may be characterized by a diameter instead of a width; these filter media may have a diameter of any suitable value (e.g., between 1 in and 124 in). Filter elements typically comprise a frame, which may be made of one or more materials such as cardboard, aluminum, steel, alloys, wood, and polymers.

In some embodiments, a filter media described herein may be a component of a filter element and may be pleated. The pleat height and pleat density (number of pleats per unit length of the media) may be selected as desired. In some embodiments, the pleat height may be greater than or equal to 10 mm, greater than or equal to 15 mm, greater than or equal to 20 mm, greater than or equal to 25 mm, greater than or equal to 30 mm, greater than or equal to 35 mm, greater than or equal to 40 mm, greater than or equal to 45 mm, greater than or equal to 50 mm, greater than or equal to 53 mm, greater than or equal to 55 mm, greater than or equal to 60 mm, greater than or equal to 65 mm, greater than or equal to 70 mm, greater than or equal to 75 mm, greater than or equal to 80 mm, greater than or equal to 85 mm, greater than or equal to 90 mm, greater than or equal to 95 mm, greater than or equal to 100 mm, greater than or equal to 125 mm, greater than or equal to 150 mm, greater than or equal to 175 mm, greater than or equal to 200 mm, greater than or equal to 225 mm, greater than or equal to 250 mm, greater than or equal to 275 mm, greater than or equal to 300 mm, greater than or equal to 325 mm, greater than or equal to 350 mm, greater than or equal to 375 mm, greater than or equal to 400 mm, greater than or equal to 425 mm, greater than or equal to 450 mm, greater than or equal to 475 mm, or greater than or equal to 500 mm. In some embodiments, the pleat height is less than or equal to 510 mm, less than or equal to 500 mm, less than or equal to 475 mm, less than or equal to 450 mm, less than or equal to 425 mm, less than or equal to 400 mm, less than or equal to 375 mm, less than or equal to 350 mm, less than or equal to 325 mm, less than or equal to 300 mm, less than or equal to 275 mm, less than or equal to 250 mm, less than or equal to 225 mm, less than or equal to 200 mm, less than or equal to 175 mm, less than or equal to 150 mm, less than or equal to 125 mm, less than or equal to 100 mm, less than or equal to 95 mm, less than or equal to 90 mm, less than or equal to 85 mm, less than or equal to 80 mm, less than or equal to 75 mm, less than or equal to 70 mm, less than or equal to 65 mm, less than or equal to 60 mm, less than or equal to 55 mm, less than or equal to 53 mm, less than or equal to 50 mm, less than or equal to 45 mm, less than or equal to 40 mm, less than or equal to 35 mm, less than or equal to 30 mm, less than or equal to 25 mm, less than or equal to 20 mm, or less than or equal to 15 mm. Combinations of the above-referenced ranges are also possible (e.g., greater than or equal to 10 mm and less than or equal to 510 mm, or greater than or equal to 10 mm and less than or equal to 100 mm). Other ranges are also possible.

In some embodiments, a filter media has a pleat density of greater than or equal to 5 pleats per 100 mm, greater than or equal to 6 pleats per 100 mm, greater than or equal to 10 pleats per 100 mm, greater than or equal to 15 pleats per 100 mm, greater than or equal to 20 pleats per 100 mm, greater than or equal to 25 pleats per 100 mm, greater than or equal to 28 pleats per 100 mm, greater than or equal to 30 pleats per 100 mm, or greater than or equal to 35 pleats per 100 mm. In some embodiments, a filter media has a pleat density of less than or equal to 40 pleats per 100 mm, less than or equal to 35 pleats per 100 mm, less than or equal to 30 pleats per 100 mm, less than or equal to 28 pleats per 100 mm, less than or equal to 25 pleats per 100 mm, less than or equal to 20 pleats per 100 mm, less than or equal to 15 pleats per 100 mm, less than or equal to 10 pleats per 100 mm, or less than or equal to 6 pleats per 100 mm. Combinations of the above-referenced ranges are also possible (e.g., greater than or equal to 5 pleats per 100 mm and less than or equal to 100 pleats per 100 mm, greater than or equal to 6 pleats per 100 mm and less than or equal to 100 pleats per 100 mm, or greater than or equal to 25 pleats per 100 mm and less than or equal to 28 pleats per 100 mm). Other ranges are also possible.

Other pleat heights and densities may also be possible. For instance, filter media within flat panel or V-bank filters may have pleat heights between ¼ in and 24 in, and/or pleat densities between 1 pleat/in and 50 pleats/in. As another example, filter media within cartridge filters or conical filters may have pleat heights between ¼ in and 24 in and/or pleat densities between ½ pleats/in and 100 pleats/in. In some embodiments, pleats are separated by a pleat separator made of, e.g., polymer, glass, aluminum, and/or cotton. In other embodiments, the filter element lacks a pleat separator. The filter media may be wire-backed, or it may be self-supporting.

The filter media and filter elements described herein may be suitable for a variety of applications. These include cabin air, face mask, room air, clean room, appliance, and gas purification applications. These filter media and filter elements may be suitable for removing contaminants from air and/or other gaseous fluids (e.g., CO₂). The fluids may include fluids breathed and/or to be breathed by living beings (e.g., fluids breathed and/or to be breathed by humans), fluids present in a mine, and/or fluids present during oil production (e.g., oil).

### Example 1

Two filter media, each comprising two layers comprising adsorptive particles, were fabricated. Their initial penetrations at 0.33 microns and break through values for a variety of species were determined both prior to and after exposure to isopropyl alcohol vapor.

The first filter media had the following design: first support layer/prefilter/first layer comprising adsorptive particles/second layer comprising adsorptive particles/second support layer. The first support layer was a spunbond poly(propylene) scrim having a basis weight of 15 g/m². The prefilter was a carded, triboelectrically-charged layer comprising dryspun poly(acrylic acid) and poly(propylene) fibers. It had a basis weight of 20 g/m². The first layer comprising adsorptive particles comprised activated carbon particles having an average diameter of 550 microns. It had a basis weight of 165 g/m². The second layer comprising adsorptive particles comprised activated carbon particles having an average diameter of 350 microns. It also had a basis weight of 165 g/m². The second support layer was a spunbond scrim having a basis weight of 50 g/m². These layers were bonded together by a sprayed-on poly(urethane) hot melt adhesive.

Ten samples of the first filter media were prepared. Of these ten samples, the average initial DEHS penetration at 0.33 microns prior to exposure to isopropyl alcohol vapor was 11.57% when the second support layer was positioned as the upstream-most layer and was 12.17% when the first support layer was positioned as the upstream-most layer. The average initial DEHS penetration at 0.33 microns after exposure to isopropyl alcohol vapor was 67.43% when the second support layer was positioned as the upstream-most layer and was 68.38% when the first support layer was positioned as the upstream-most layer.

The second filter media had the following design: first support layer/nanofiber layer/prefilter/first layer comprising adsorptive particles/second layer comprising adsorptive particles/second support layer. The support layers and layers comprising adsorptive particles were the same as those for the first filter media. The nanofiber layer comprised nylon 6 fibers having a diameter of 0.12 microns. The prefilter was a hydrocharged meltblown layer comprising poly(propylene) fibers. It had a basis weight of 23 g/m². These layers were bonded together by a sprayed-on poly(urethane) hot melt adhesive.

Ten samples of the second filter media were prepared. Of these ten samples, the average initial DEHS penetration at 0.33 microns prior to exposure to isopropyl alcohol vapor was 4.052% when the second support layer was positioned as the upstream-most layer and was 4.144% when the first support layer was positioned as the upstream-most layer. The average initial DEHS penetration at 0.33 microns after exposure to isopropyl alcohol vapor was 47.17% when the second support layer was positioned as the upstream-most layer and was 46.19% when the first support layer was positioned as the upstream-most layer. Accordingly, the second filter media exhibited lower values of penetration than the first filter media both before and after exposure to isopropyl alcohol vapor. Additionally, the second filter media retained a relatively low value of penetration after exposure to isopropyl alcohol vapor, indicating that it is capable of maintaining its performance even in oily environments.

The break through of n-butane, toluene, SO₂, and NOₓ were measured at a variety of time points for both the first and the second filter media before exposure to isopropyl alcohol and after exposure to isopropyl alcohol vapor. Both filter media had values of break through and capacity that were less than or equal to the values listed below in Table 3 both before and after such exposure, which indicates that they are well-suited for removing these contaminants from air.

TABLE 3

| Contaminant | Break | Break | Break | |
|---|---|---|---|---|
| (concentration | through | through | through | |
| in impinging | after | after | after | |
| air stream) | 0 minutes | 1 minute | 5 minutes | Capacity* |
| n-butane | 5% | 15% | 40% | 8 |
| (80 ppm) | | | | |
| Toluene | 5% | 7% | 10% | 40 |
| (80 ppm) | | | | |
| SO₂ (30 ppm) | 10% | 15% | 40% | 5.5 |
| NOₓ (30 ppm) | 5% | | 10% | 11 |

*May be determined by integrating the values for break through over time across a time period beginning with the 0 minute time point and ending with the 60 minute time point.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited. In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

What is claimed is:

1. A filter media, comprising:
a first non-woven fiber web, wherein the first non-woven fiber web comprises fibers having an average fiber diameter of less than or equal to 1 micron; and
a layer comprising adsorptive particles, wherein the layer comprising adsorptive particles is discrete from the first non-woven fiber web.

2. A filter media, comprising:
a first non-woven fiber web, wherein the first non-woven fiber web comprises fibers having an average fiber diameter of less than or equal to 1 micron; and
a layer comprising adsorptive particles, wherein fibers make up less than or equal to 20 wt % of the layer comprising adsorptive particles.

3. A filter media, comprising:
a first non-woven fiber web, wherein the first non-woven fiber web comprises fibers having an average fiber diameter of less than or equal to 1 micron; and
a layer comprising adsorptive particles in an amount such that the adsorptive particles have a basis weight of greater than or equal to 90 g/m² and less than or equal to 1000 g/m².

4-6. (canceled)

7. The filter media of claim 1, wherein the adsorptive particles are configured to remove a species from air by adsorption.

8. (canceled)

9. The filter media of claim 7, wherein the species comprises a volatile organic compound, an acidic gas, a basic gas, an aldehyde, and/or benzene.

10. The filter media of claim 7, wherein the species comprises SO₂, NOₓ, toluene, n butane, H₂S, and/or ammonia.

11-12. (canceled)

13. The filter media of claim 1, wherein the adsorptive particles comprise activated carbon.

14. The filter media of claim 13, wherein the activated carbon is surface treated.

15-25. (canceled)

26. The filter media of claim 1, wherein the layer comprising adsorptive particles further comprises a binder.

27. The filter media of claim 26, wherein the binder comprises an adhesive.

28. The filter media of claim 26, wherein the binder comprises bicomponent fibers.

29-33. (canceled)

34. The filter media of claim 1, wherein the first non-woven fiber web is surface-modified to have an oleophobic coating, a hydrophobic coating, and/or a fluorinated coating.

35-36. (canceled)

37. The filter media of claim 1, wherein the first non-woven fiber web is charged.

38. (canceled)

39. The filter media of claim 1, wherein the filter media comprises a second non-woven fiber web.

40. The filter media of claim 39, wherein the second non-woven fiber web is a meltblown fiber web, a spunbond fiber web, a carded fiber web, or a wetlaid fiber web.

41-42. (canceled)

43. The filter media of claim 39, wherein the second non-woven fiber web comprises acrylic and poly(propylene) fibers.

44-62. (canceled)

63. The filter media of claim 39, wherein the second non-woven fiber web comprises is an electret charge.

64. (canceled)

65. The filter media of claim 39, wherein the second non-woven fiber web is a charged, meltblown non-woven fiber web.

66-84. (canceled)

85. The filter media of claim 39, wherein the second non-woven fiber web comprises staple fibers.

86. The filter media of claim 39, wherein the second non-woven fiber web comprises two types of fibers having different dielectric constants.
